(19) United States
(12) Patent Application Publication
(10) Pub. No.: US 2010/0115080 A1
(43) Pub. Date: May 6, 2010

(54) METHOD OF CONTROLLING THE COMMUNICATION BETWEEN A MACHINE USING PRIVATE ADDRESSES AND A COMMUNICATION DEVICE CONNECTED TO A GLOBAL NETWORK

(76) Inventor: Soshi KAGEYAMA, Kokubunji-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/613,377

(22) Filed: Nov. 5, 2009

(30) Foreign Application Priority Data
Nov. 6, 2008 (JP) 2008-285580

(51) Int. Cl. G06F 15/173; G06F 21/00

(52) U.S. Cl. 709/223; 726/12

(57) ABSTRACT

According to one embodiment, when having received first communication data addressed to a machine migrated to a second network address port translation module, a first network address port translation module translates a destination network address in the first communication data into a global address of the second network address port translation module. The first network address port translation module transfers the translated first communication data as second communication data to the second network address port translation module. When having received the second communication data transferred by the first network address port translation module, the second network address port translation module transmits third communication data addressed to the machine corresponding to the second communication data to the machine.

### CROSS-REFERENCE TO RELATED APPLICATIONS

This application is based upon and claims the benefit of priority from prior Japanese Patent Application No. 2008-285580, filed Nov. 6, 2008, the entire contents of which are incorporated herein by reference.

### BACKGROUND OF THE INVENTION

1. Field of the Invention

One embodiment of the invention relates, for example, to a computer system with network address port translation modules which are provided for a plurality of private networks in a one-to-one correspondence and which connect the corresponding private networks with a global network and communicate with each other via the global network. More particularly, the one embodiment relates to a method of controlling the communication between a machine using private addresses and a communication device connected to the global network.

2. Description of the Related Art

Generally, a virtual machine monitor (VMM) operates on a real hardware unit. An environment where a plurality of virtual machines which emulate a hardware unit on the virtual machine monitor can exist is called a virtual machine environment (or virtualization environment). In such a virtual machine environment, on each of the plurality of virtual machines, an operating system (hereinafter, referred to as a guest OS) can be operated. This makes it possible to build a plurality of guest OS environments on a single hardware unit.

Virtual machine monitors are classified into two types. A first type of virtual machine monitor is realized as a module existing in a kernel of an operating system (hereinafter, referred to as a host OS) which operates on a hardware unit. A second type of virtual machine monitor is realized as a kernel called a hypervisor. By using either type of virtual machine monitor, a plurality of guest OS environments can be built on one hardware unit. A virtual machine operating in a guest OS environment realized by a virtual machine monitor emulates a request from the guest OS to the hardware unit, regardless of the type of the virtual machine monitor. The virtual machine monitor receives the emulated request from the virtual machine and accesses the hardware unit.

Here, suppose a case where a single hardware unit is caused to have a plurality of guest OS environments by use of a virtual machine environment, that is, a case where more and more servers are consolidated. In this case, the number of virtual machines increases on the order of several times the number of physical hardware units. In such a situation, IP (Internet Protocol) addresses are expected to run short.

To deal with the shortage of IP addresses, the following mechanism is known. First, in a virtual machine environment, a virtual private network (virtual network) is prepared for each virtual machine. An external global network and a virtual private network are connected to each other with a network address port translation (NAPT) module. The NAPT module exists on a virtual machine monitor. The address spaces of the global network and private network connected via the NAPT module are called a global address space of the NAPT module and a private address space of the NAPT module, respectively. It should be noted that the above mechanism uses the NAPT module, not a network address translation (NAT) module. The reason for this is that, if a NAT module is used, as many global IP addresses as there are guest OSs communicating simultaneously are needed, making it difficult to solve the IP address shortage problem.

For example, Jpn. Pat. Appln. KOKAI Publication No. 2006-244481 (hereinafter, referred to as the prior art document) has disclosed a virtual machine environment where a plurality of hardware units each having a virtual machine monitor are connected to a shared disk device which stores guest OS images. In such a virtual machine environment, a guest OS (virtual machine) can be migrated between the virtual machine monitors operating on the corresponding hardware units. More specifically, in the virtual machine environment, it is possible to migrate the guest OS from a private network (virtual private network) connected to the global network via the NAPT module operating on a virtual machine monitor to another private network connected to the global network by another NAPT module operating on another virtual machine monitor. That is, in the virtual machine environment, the guest OS can be migrated from a NAPT module to another NAPT module. The guest OS image is a storage image of the guest OS which has been installed and set in a storage area.

The migration of a virtual machine (guest OS) between virtual machine monitors operating on the corresponding hardware units as described in the prior art document is used in various situations. For example, when a certain hardware unit is stopped, it is possible to migrate the virtual machine running in the virtual machine environment realized by the virtual machine monitor operating on the hardware unit (that is, the virtual machine monitor the hardware unit has) to a virtual machine monitor operating on another hardware unit (on the NAPT module side). Moreover, when the load on the certain hardware unit has increased, the virtual machine monitor can be migrated to a virtual machine monitor operating on another hardware unit with a low load (on the NAPT module side).

However, with the above mechanism, when the virtual machine is migrated to the side of the NAPT module existing on the virtual machine monitor another hardware unit has (that is, the private address space of another NAPT module), there is a possibility that the communication will be disconnected. The reason for this is that the global address differs from one NAPT module to another. That is, the migration of a virtual machine using an address (private address) in the private address space to another NAPT module side leads to a change of the IP address at the communication destination on the part of an external communication device which communicates with the virtual machine via the global network.

Accordingly, a method of taking over addresses as in making NAPT modules redundant can be considered. However, the global address a NAPT module has is shared by virtual machines currently running. Therefore, the NAPT module at the migration destination is not simply allowed to take over the global address unless all the virtual machines are migrated simultaneously. Such a problem arises similarly even in a computer system where a machine using private addresses is a real machine (i.e., physical computer) and the real machine can be migrated between network address port translation modules operating on hardware units.

### BRIEF SUMMARY OF THE INVENTION

According to one embodiment of the invention, there is provided a method of controlling the communication between a machine using private addresses and a communication device connected to a global network in a computer system which includes a first network address port translation module for connecting a first private network and the global network and a second network address port translation module for connecting a second private network and the global network. The method comprises: detecting, by the second address port translation module, a migration of the machine from the first network address port translation module to the second network address port translation module; storing address port translation data stored in a first storage module included in the first network address port translation module into a second storage module included in the second network address port translation module in order that the second network address port translation module may share the address port translation data with the first network address port translation module, the address port translation data being used to translate a network address and a port number included in communication data on the machine; translating, by the first network address port translation module, first communication data into second communication data when the first network address port translation module has received the first communication data, the first communication data being communication data addressed to the machine which has been transmitted from the communication device via the global network to the first network address port translation module in a state where the machine has been migrated from the first network address port translation module to the second network address port translation module and which includes a global address of the first network address port translation module as a destination network address, and the second communication data being generated by translating a destination network address in the first communication data into a global address of the second network address port translation module; transferring the second communication data from the first network address port translation module to the second network address port translation module; causing the second network address port translation module to translate the second communication data transferred to the second network address port translation module into third communication data, the third communication data being generated by translating a destination network address and a destination port number in the second communication data on the basis of address port translation data which is shared with the first network address port translation module and stored in the second storage module; and transmitting the third communication data to the machine via the second private network.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing the configuration of a virtual machine system according to an embodiment of the invention;

FIG. 2 is a sequence chart to explain a communication sequence before and after the migration of a guest OS in the embodiment;

FIG. 3 shows communication data addressed to the guest OS transmitted from a communication device communicating with the guest OS to a network address port translation (NAPT) module before the migration of the guest OS in the communication sequence of FIG. 2 and communication data transmitted from the NAPT module to the guest OS in such a manner that the former and the latter are caused to correspond to each other;

FIG. 4 shows communication data addressed to a communication device transmitted from the guest OS before the migration of the guest OS in the communication sequence of FIG. 2 and communication data transmitted from the NAPT module to the communication device in such a manner that the former and the latter are caused to correspond to each other;

FIG. 5 shows an example of address port translation data transmitted from an NAPT (migration source NAPT) on a migration source virtual machine monitor to an NAPT (migration destination NAPT) on a migration destination virtual machine monitor during the migration of the guest OS in the communication sequence of FIG. 2;

FIG. 6 shows communication data addressed to the guest OS transmitted from a communication device to a migration source NAPT after the migration of the guest OS in the communication sequence of FIG. 2 and communication data addressed to the guest OS relayed from the migration source NAPT to a migration destination NAPT in such a manner that the former and the latter are caused to correspond to each other;

FIG. 7 shows communication data addressed to the guest OS relayed from the migration source NAPT to a migration destination NAPT after the migration of the guest OS in the communication sequence of FIG. 2 and communication data transmitted from the migration destination NAPT to the guest OS in such a manner that the former and the latter are caused to correspond to each other;

FIG. 8 shows communication data addressed to a communication device transmitted from the guest OS after the migration of the guest OS in the communication sequence of FIG. 2 and communication data transmitted from the migration destination NAPT to the communication device in such a manner that the former and the latter are caused to correspond to each other;

FIG. 9 is a block diagram showing a configuration of the virtual machine monitor shown in FIG. 1;

FIG. 10 shows an example of the data structure of a migration destination address table shown in FIG. 9;

FIG. 11 shows an example of the data structure of a migration source address table shown in FIG. 9;

FIG. 12 shows an example of the data structure of an address port translation table shown in FIG. 9;

FIG. 13 is a flowchart to explain the operating procedure for a guest OS status reception module shown in FIG. 9;

FIG. 14 shows an example of migration stop data generated by the guest OS status reception module;

FIG. 15 is a flowchart to explain the operating procedure for a communication data determination module shown in FIG. 9;

FIG. 16 is a diagram to explain the operation of adding address port translation data to the migration source address table;

FIG. 17 is a diagram to explain the operation of deleting data from an entry of the migration destination address table on the basis of migration stop data;

FIG. 18 is a diagram to explain the operation of translating communication data addressed to the guest OS transmitted from a communication device communicating with the guest OS to the migration destination NAPT into communication data addressed to the guest OS relayed from the migration source NAPT to the migration destination NAPT;

FIG. 19 is a diagram to explain the operation of translating communication data addressed to the guest OS transmitted from a communication device communicating with the guest OS to NAPT into communication data transmitted from the NAPT to the guest OS;

FIG. 20 is a diagram to explain the operation of translating communication data addressed to a communication device transmitted from the guest OS into communication data transmitted from NAPT to the communication device;

FIG. 21 is a diagram to explain the operation of translating communication data addressed to a communication device transmitted from the guest OS into communication data transmitted from the migration destination NAPT to the communication device;

FIG. 22 is a diagram to explain the operation of translating communication data addressed to the guest OS relayed from the migration source NAPT to the migration destination NAPT into communication data transmitted from the migration destination NAPT to the guest OS;

FIG. 23 is a block diagram showing the configuration of a virtual machine system according to a modification of the embodiment;

FIG. 24 is a sequence chart to explain a communication sequence before and after the occurrence of a failure in the migration source NAPT in the modification;

FIG. 25 shows an example of gratuitous ARP transmitted from the migration destination NAPT when the migration destination NAPT detects the occurrence of a failure in the migration source NAPT in the communication sequence of FIG. 24;

FIG. 26 shows communication data addressed to the guest OS transmitted from a communication device communicating with the guest OS after the transmission of gratuitous ARP in the communication sequence of FIG. 24 and communication data transmitted from the migration destination NAPT to the guest OS in such a manner that the former and the latter are caused to correspond to each other;

FIG. 27 shows communication data addressed to a communication device transmitted from the guest OS after the transmission of gratuitous ARP in the communication sequence of FIG. 24 and communication data transmitted from the migration destination NAPT to the communication device in such a manner that the former and the latter are caused to correspond to each other;

FIG. 28 is a block diagram showing a configuration of the virtual machine monitor shown in FIG. 23;

FIG. 29 is a flowchart to explain the procedure for a heartbeat periodic transmission process performed by a failure detection module shown in FIG. 28;

FIG. 30 is a diagram to explain the operation of generating heartbeat data;

FIG. 31 is a flowchart to explain the procedure for a failure detection process performed by a failure detection module of FIG. 28; and

FIG. 32 is a diagram to explain the operation of migrating to an address port translation table the data in an entry of the migration source address table including the global address of the migration source NAPT from which a heartbeat interruption has been detected.

### DETAILED DESCRIPTION OF THE INVENTION

Embodiments of the invention will be described with reference to the accompanying drawings.

<Configuration of Virtual Machine System>

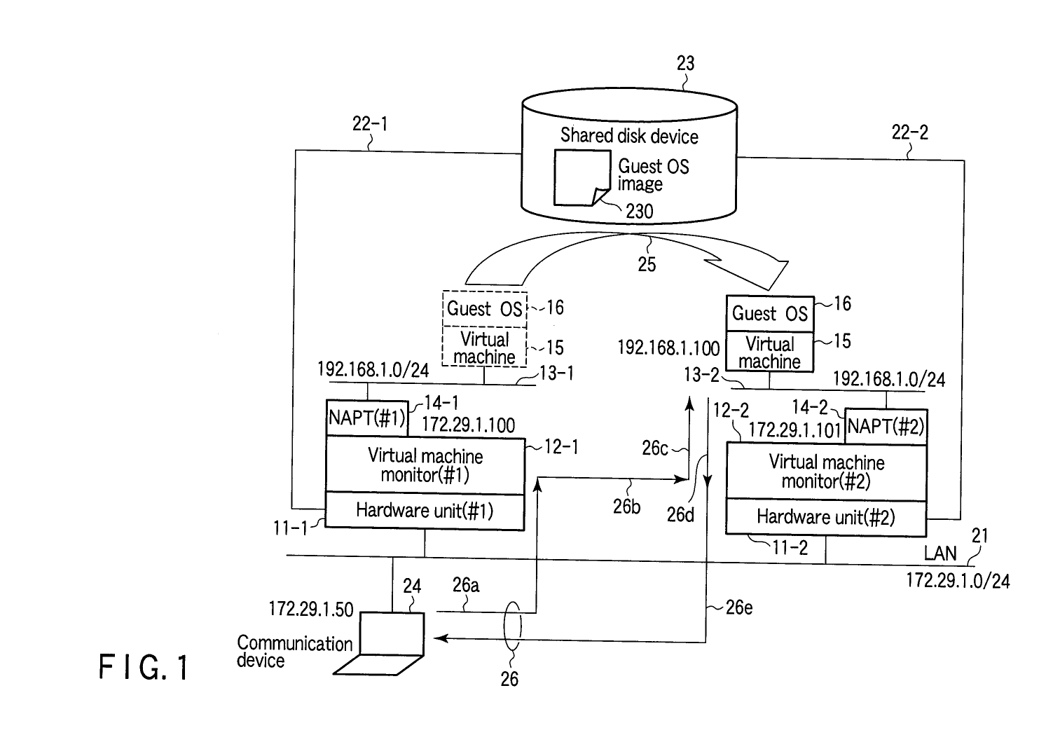

FIG. 1 is a block diagram showing the configuration of a virtual machine system (or computer system) according to an embodiment of the invention. In FIG. 1, on hardware units 11-1 (#1) and 11-2 (#2), virtual machine monitors 12-1 (#1) and 12-2 (#2) are provided, respectively. Each of the hardware units 11-1 and 11-2 includes a CPU, a memory, and an input/output device (which are not shown).

A virtual network 13-1 (#1) serving as a virtual private network and an NAPT module (hereinafter, referred to as NAPT) 14-1 (#1) are built on virtual machine monitor 12-1. A virtual network 13-2 (#2) and an NAPT 14-2 (#2) are built on virtual machine monitor 12-2. That is, virtual machine monitor 12-1 includes virtual network 13-1 and NAPT 14-1, whereas virtual machine monitor 12-2 includes virtual network 13-2 and NAPT 14-2.

Virtual network 13-1 is connected to, for example, a local area network (LAN) 21 serving as an external global network via NAPT 14-1, whereas virtual network 13-2 is connected to LAN 21 via NAPT 14-2. The address spaces of virtual network (private network) 13-i and LAN (global network) 21 connected via NAPT 14-i (i=1, 2) are called a private address space of NAP 14-i and a global address space of NAPT 14-i, respectively.

NAPT 14-i has the function of performing translation (address port translation) between a network address (private address) and a port number in the private address space and a network address (global address) and a port number in the global address space. NAPT 14-i further has the function of performing translation between network addresses in the global address space. More specifically, when NAPT 14-i itself is migration source NAPT 14-i described later, it further has the function of translating the global address (IP address) of migration source NAPT 14-i into the global address (IP address) of the migration destination NAPT.

In the example of the system of FIG. 1, suppose a case where a virtual machine 15 connected to virtual network 13-1 on the virtual machine monitor 12-1 side on hardware unit 11-1 and a guest OS 16 operating on the virtual machine 15 are migrated to virtual network 13-2 on the virtual machine monitor 12-2 side on hardware unit 11-2. Hardware units 11-1 and 11-2 are connected to a shared disk device 23 via, for example, storage area networks (SAN) 22-1 and 22-2, respectively. In the storage area of the shared disk device 23, a guest OS image 230 to realize guest OS 16 has been stored.

Each of NAPT 14-1 and NAPT 14-2 has a global address. Therefore, when guest OS 16 before migration communicates with a communication device 24, such as an external client terminal outside the virtual machine system, via virtual machine network 13-1, NAPT 14-1 replaces the private address of guest OS 16 (source IP address) with the global address of NAPT 14-1. On the other hand, when communication device 24 communicates with guest OS 16 via LAN 21, NAPT 14-1 replaces the global address of NAPT 14-1 (destination IP address) with the private address of guest OS 16.

However, as shown by arrow 25 in FIG. 1, when virtual machine 15 and guest OS 16 have been migrated from hardware unit 11-1 (NAPT 14-1 on virtual machine monitor 12-1) to hardware unit 11-2 (NAPT 14-2 on virtual machine monitor 12-2), the communication between guest OS 16 and communication device 24 breaks up.

To overcome this problem, communication data sent and received between guest OS 16 (or virtual machine 15) and communication device 24 is transferred between NAPT 14-1 on the hardware unit 11-1 (or virtual machine monitor 12-1) side and NAPT 14-2 on hardware unit 11-2 (or virtual machine monitor 12-2) side as shown by an arrow group 26 in FIG. 1. In the example of FIG. 1, hardware unit 11-1 is the migration source of guest OS 16 and hardware unit 11-2 is the migration destination of guest OS 16.

Specifically, NAPT 14-1 (i.e., migration source NAPT 14-1) transfers communication data addressed to guest OS 16 sent from communication device 24 to NAPT 14-1 as shown by arrow 26a in FIG. 1 to NAPT 14-2 (i.e., migration destination NAPT 14-1) as shown by arrow 26b in FIG. 1. When the communication data is transferred, NAPT 14-1 translates the destination IP address (i.e., destination network address) from the global address of NAPT 14-1 to the global address of NAPT 14-2. NAPT 14-2 transmits the communication data transferred from NAPT 14-1 to the migrated guest OS 16 via virtual network 13-2 as shown by arrow 26c in FIG. 1. When the communication data is transmitted, NAPT 14-2 translates the destination IP address from the global address of NAPT 14-2 to the private address of guest OS 16. As described above, NAPT 14-2 relays the communication data addressed to guest OS 16 sent from communication device 24 to NAPT 14-1 and transmits the data via virtual network 13-2 to guest OS 16.

Next, suppose a case where the communication data addressed to communication device 24 from the migrated guest OS 16 has been sent onto virtual network 13-2 as shown by arrow 26d in FIG. 1. In this case, NAPT 14-2 directly transmits the communication data addressed to communication device 24 via LAN 21 to communication device 24 as shown by arrow 26e in FIG. 1. When the communication data is transmitted, NAPT 14-2 translates the source IP address (i.e., source network address) from the private address of guest OS 16 to the global address of NAPT 14-1. This enables communication device 24 to communicate with guest OS 16 via NAPT 14-1 regardless the migration of guest OS 16.

As described above, with the embodiment, the communication data of guest OS 16 migrated between hardware units 11-1 and 11-n is transferred between migration source NAPT 14-1 and migration destination NAPT 14-2. That is, in the embodiment, the flow goes as follows:

(1) The communication data addressed to guest OS 16 from communication device 24 is transferred from migration source NAPT 14-1 to migration destination NAPT 14-2 as a result of migration source NAPT 14-1 using the global address of migration destination NAPT 14-2 as the destination IP address. The transferred communication data is sent from migration destination NAPT 14-2 to guest OS 16 (refer to arrows 26a to 26c in FIG. 1).

(2) The communication data transmitted from guest OS 16 is directly transmitted from NAPT 14-2 to communication device 24 as a result of migration destination NAPT 14-2 using the global address of migration source NAPT 14-1 as the source IP address (refer to arrows 26d and 26e in FIG. 1).

<Communication Sequence Before and After the Migration of Guest OS>

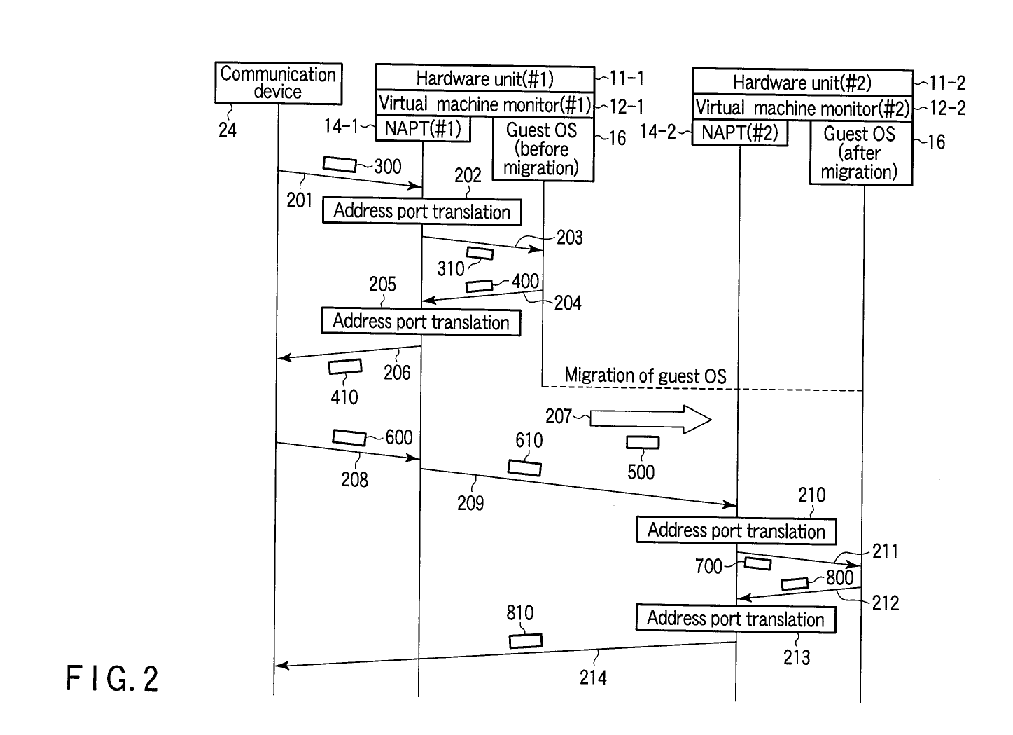

Next, a communication sequence before and after the migration of guest OS 16 applied to the system of FIG. 1 will be explained with reference to a sequence chart in FIG. 2, taking as an example a case where communication data is sent and received between guest OS 16 and communication device 24. As shown in FIG. 1, suppose the network addresses of virtual networks 13-1 and 13-2 are “192.268.1.10/24” and the network address of LAN 21 is “172.29.1.0/24”. Moreover, suppose the global addresses of NAPT 14-1 and NAPT 14-2 are “172.29.1.100” and “172.29.1.101”, respectively.

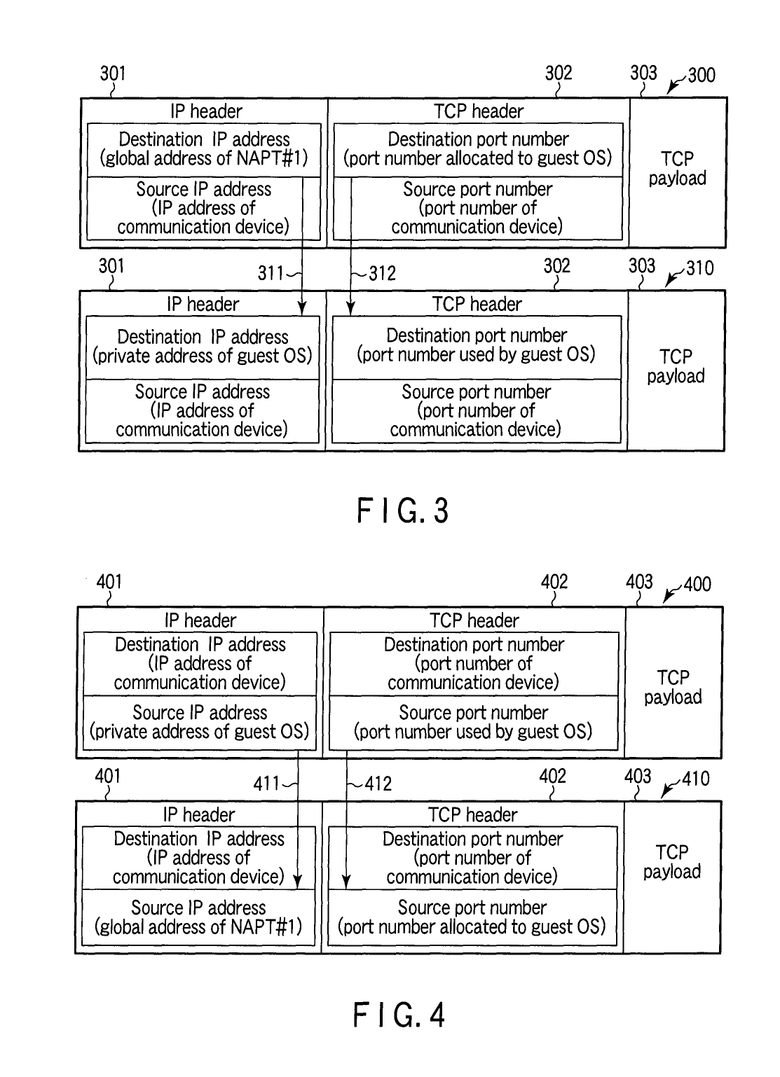

First, the communication between guest OS 16 and communication device 24 performed before the migration of guest OS 16 will be explained with reference to the sequence chart of FIG. 2 and examples of communication data in FIGS. 3 and 4. When having to communicate with guest OS 16, communication device 24 transmits communication data 300 addressed to guest OS 16 in the format shown in FIG. 3 to NAPT 14-1 (#1) via LAN 21 (step 201).

The communication data 300 includes an IP header 301, a TCP (Transmission Control Protocol) (or UDP (User Datagram Protocol)) header 302, and a TCP (or UDP, same as above) payload 303. The IP header 301 is composed of a destination IP address and a source IP address. The global address of NAPT 14-1 is used as the destination IP address of IP header 301. The IP address of communication device 24 is used as the source IP address of IP header 301. The port number allocated to guest OS 16 by NAPT 14-1 is used as the destination port number of TCP header 302. The port number of communication device 24 is used as the source port number of TCP header 302. Instead of TCP header 302 and TCP payload 303, UDP (User Datagram Protocol) header and UDP payload may be used, respectively.

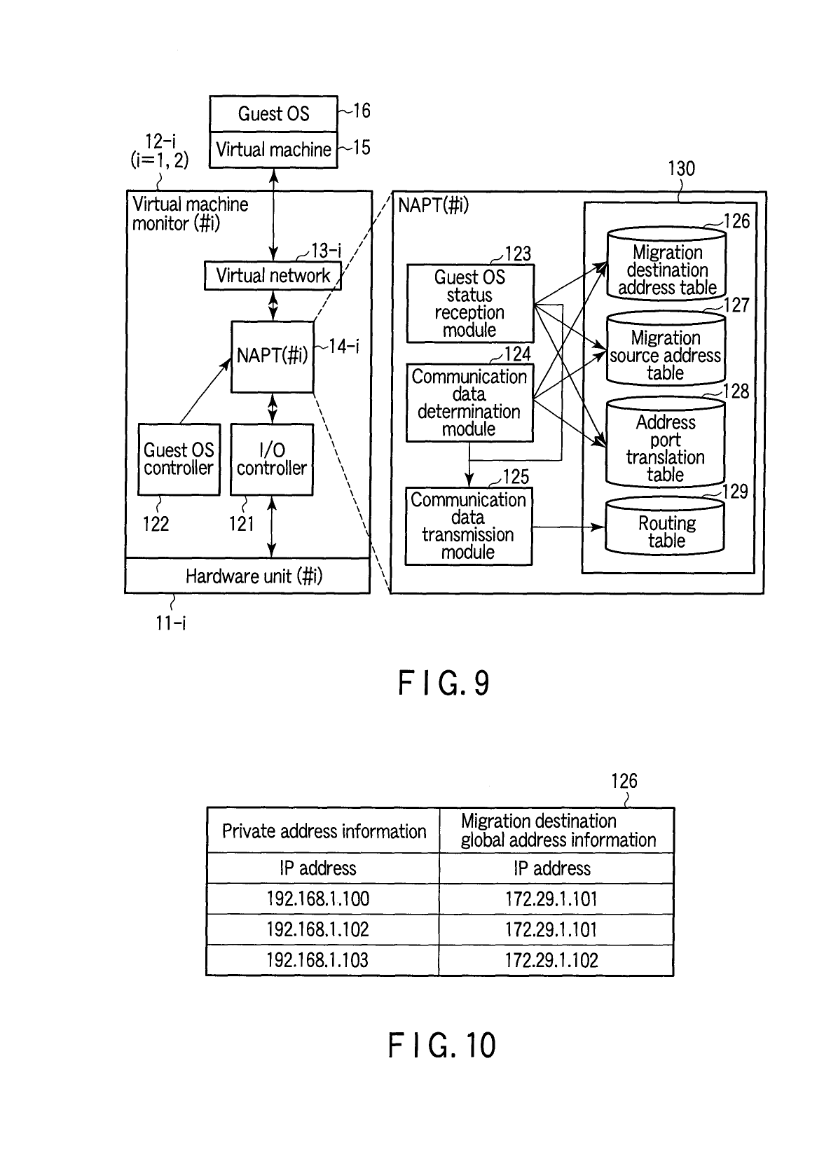

NAPT 14-1 receives communication data 300 from communication device 24 on the basis of the destination IP address of communication data 300. Then, NAPT 14-1 replaces or translates the destination IP address and destination port number (or does address port translation) on the basis of its own address port translation table 128 (see FIG. 9) (step S202). In this step, the destination IP address of IP header 301 included in communication data 300 is translated from the global address of NAPT 14-1 into the private address of guest OS 16 as shown by arrow 311 in FIG. 3. Moreover, the destination port number of TCP header 302 included in communication data 300 is translated from the port number allocated to guest OS 16 by NAPT 14-1 into a port number used by guest OS 16 as shown by arrow 312 in FIG. 3. NAPT 14-1 transmits communication data 300 subjected to address port translation as communication data 310 of FIG. 3 to guest OS 16 via virtual network 13-1 (step 203). Guest OS 16 receives communication data 310 via the port specified by the destination port number of TCP header 302.

Next, suppose guest OS 16 has transmitted communication data 400 in the format of FIG. 4 to NAPT 14-1 via virtual network 13-1 to respond to, for example, communication data 310 (step 204). Communication data 400 includes an IP header 401, a TCP header 402, and a TCP payload 403. The IP header 401 is composed of a destination IP address and a source IP address. The IP address of communication device 24 is used as the destination IP address of IP header 401. The private address of guest OS 16 is used as the source IP address of IP header 401. The port number of communication device 24 is used as the destination port number of TCP header 402. The port number used by guest OS 16 is used as the source port number of TCP header 402.

NAPT 14-1 receives communication data 400 from guest OS 16. Then, NAPT 14-1 translates the source IP address and source port number (or does address port translation) on the basis of its own address port translation table 128 (see FIG. 9) (step 205). In this step, the source IP address of IP header 401 included in communication data 400 is translated from the private address of guest OS 16 into the global address of NAPT 14-1 as shown by arrow 411 in FIG. 4. Moreover, the source port number of TCP header 402 included in communication data 400 is translated from the port number used by guest OS 16 into the port number allocated to guest OS 16 by NAPT 14-1 as shown by arrow 412 in FIG. 4.

NAPT 14-1 transmits communication data 400 subjected to address port translation as communication data 410 of FIG. 4 to communication device 24 via LAN 21 (step 206). Communication device 24 receives the communication data 410.

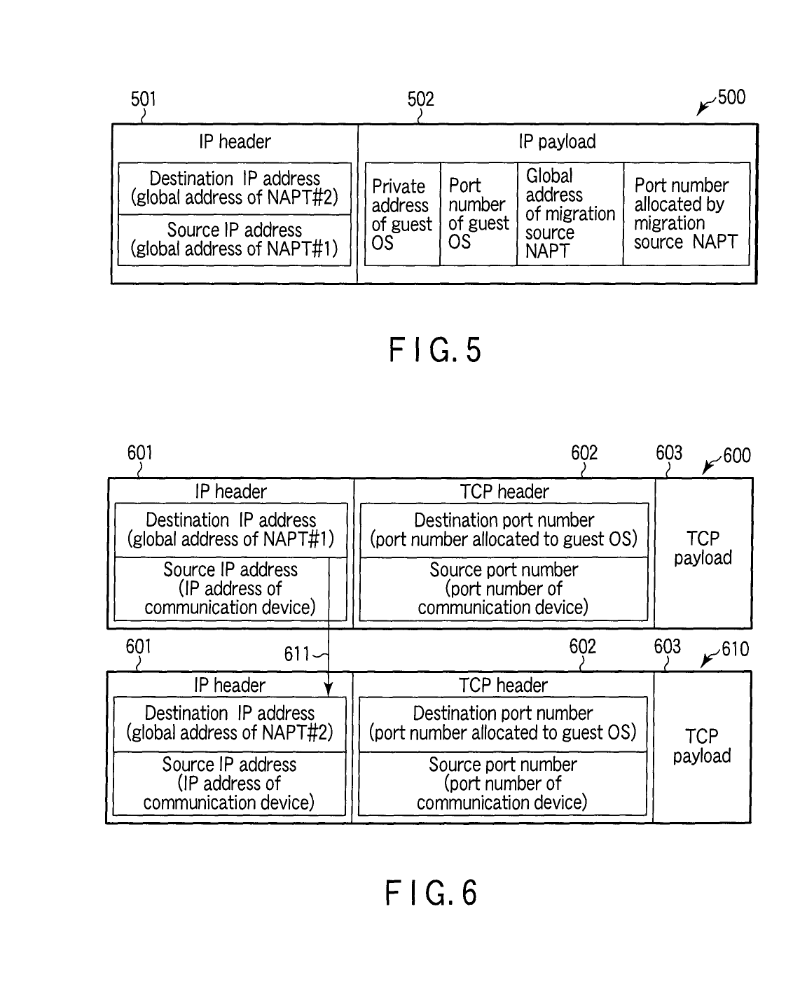

Next, communication performed when guest OS 16 (or guest OS 16 and virtual machine 15) migrates will be explained with reference to the communication sequence of FIG. 2 and an example of communication data (or address port translation data) in FIG. 5. Here, suppose guest OS 16 (guest OS 16 and virtual machine 15) operating on the hardware unit 11-1 (or virtual machine monitor 12-1) side is migrated to the hardware unit 11-2 (or virtual machine monitor 12-2) side. When migrating between hardware units 11-1 and 11-2, guest OS 16 transmits address port translation data (address port translation data packet) 500 in the format of FIG. 5 from migration source NAPT 14-1 (#1) to migration destination NAPT 14-2 (#2) (step 207).

Address port translation data 500 is communication data which includes an IP header 501 and an IP payload 502. IP header 501 is composed of a destination IP address and a source IP address. The global address of migration destination NAPT 14-2 is used as the destination IP address of IP header 501. The global address of NAPT 14-1 is used as the source IP address of IP header 501. IP payload 510 includes the private address of guest OS 16, the port number of guest OS 16 (the port number used by guest OS 16), the global address of migration source NAPT 14-1, and the port number allocated to guest OS 16 by migration source NAPT 14-1. The data of the IP payloads 502 may be held in TCP payloads.

Suppose NAPT 14-1 has transmitted address port translation data 500 to NAPT 14-2 and the data 500 has been received by NAPT 14-2. That is, the exchange of address port translation data 500 between NAPT 14-1 and NAPT 14-2 has been completed. From this point on, NAPT 14-1 and NAPT 14-2 process communication data on guest OS 16 in the following sequence according the sequence chart of FIG. 2. First, suppose, like communication data 300 shown in FIG. 3, communication device 24 has transmitted communication data 600 in the format of FIG. 6 to NAPT 14-1 (#1) via LAN 21 (step 208) to communicate with guest OS 16.

Communication data 600 includes an IP header 601, a TCP header 602, and a TCP payload 603. IP header 601 is composed of a destination IP address and a source IP address. The global address of NAPT 14-1 is used as the destination IP address of IP header 601 as in communication data 300 shown in FIG. 3 (that is, as before the migration of guest OS 16). As described above, in the embodiment, even if guest OS 16 has been migrated from the NAPT 14-1 side (virtual network 13-1 of the NAPT 14-1 side) to the NAPT 14-2 side (virtual network 13-2 of the NAPT 14-2 side), the global address used in communication device 24 connected to LAN 21 remains unchanged. The IP address of communication device 24 is used as the source IP address of IP header 601. The port number allocated to guest OS 16 by NAPT 14-1 is used as the destination port number of TCP header 602. The port number of communication device 24 is used as the source port number of TCP header 602.

NAPT 14-1 receives communication data 600 from communication device 24. Then, NAPT 14-1 changes the destination IP address of IP header 601 included in communication data 600 from the global address of NAPT 14-1 to the global address of NAPT 14-2 as shown by arrow 611 in FIG. 6. NAPT 14-1 transfers the communication data 600 with the changed destination IP address as communication data 610 to NAPT 14-2 (#2) via LAN 21 (step 209).

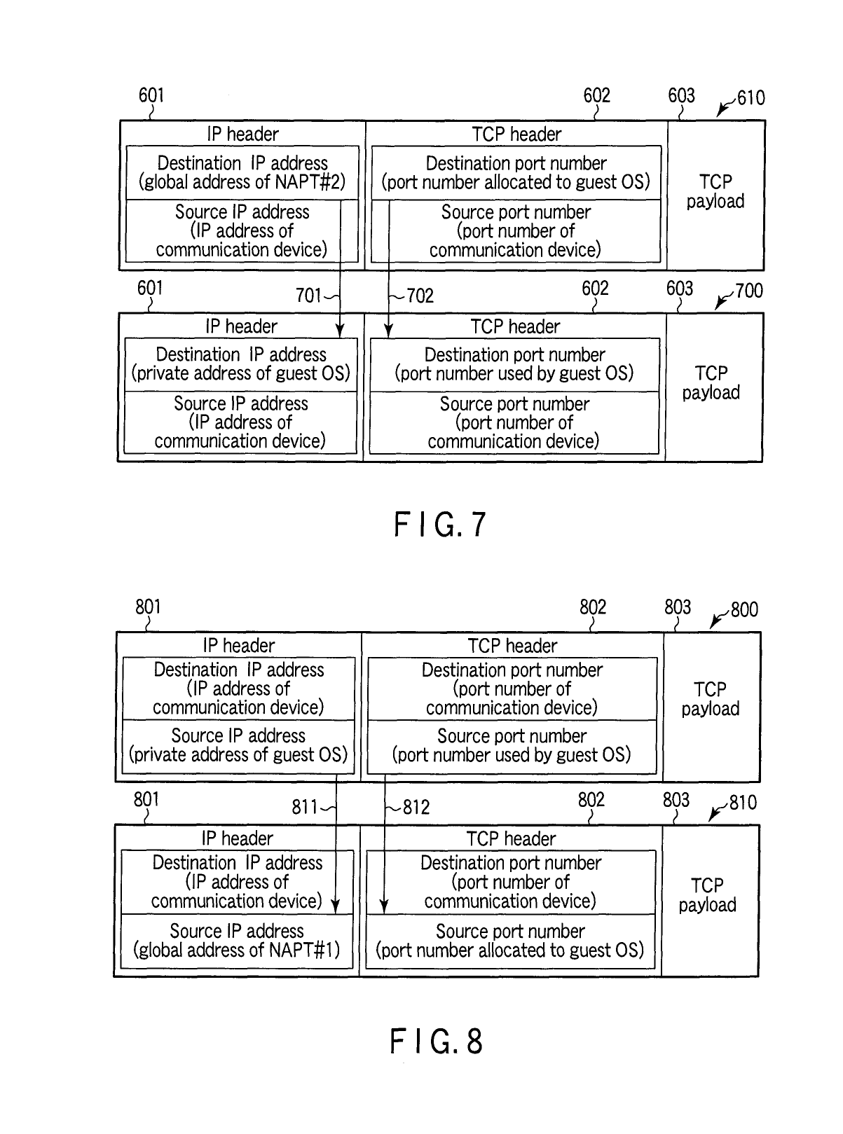

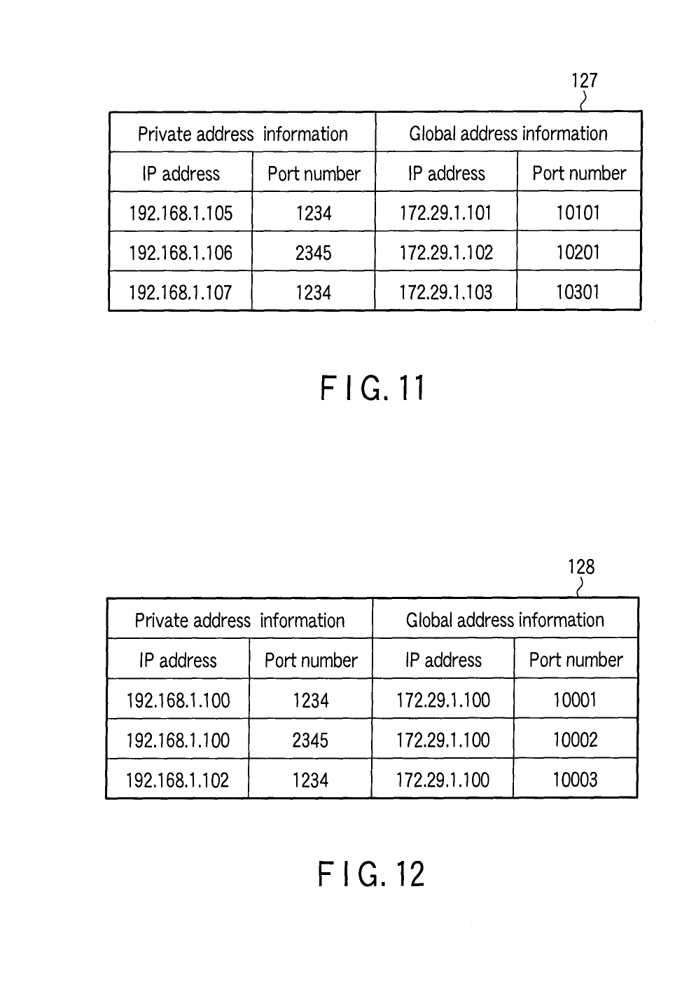

NAPT 14-2 receives communication data 610 transferred by NAPT 14-1 on the basis of the destination IP address of communication data 610. Then, NAPT 14-2 translates the destination IP address and destination port number (or does address port translation) on the basis of a migration source address table 127 (see FIG. 11) described later NAPT 14-1 has (step 210). In this step, the destination IP address of IP header 601 included in communication data 610 is translated from the global address of NAPT 14-2 into the private address of guest OS 16 as shown by arrow 701 in FIG. 7. Moreover, the destination port number of TCP header 602 included in communication data 610 is translated from the port number allocated to guest OS 16 by NAPT 14-1 into the port number used by guest OS 16 as shown by arrow 702 in FIG. 7.

This translation needs information to uniquely identify a guest OS (in this case, guest OS 16) serving as the destination of communication data 610. As such information, the MAC address of a hardware unit (hardware unit 11-1) including NAPT (in this case, NAPT 14-1), the port number allocated to the guest OS (the port number in global address information), or the like may be used. Here, it is necessary to set the port number allocated to the guest OS so that the number may be unique in NAPT 14-i (i=1, 2) on each virtual network 13-i included in a certain range to which the guest OS might be migrated. In the embodiment, suppose a port number which is allocated to the guest OS and is set so as to be unique in NAPT 14-i on each virtual network 13-i included in a certain range to which the guest OS might be migrated is used as information to uniquely identify the guest OS. NAPT 14-2 transmits communication data 610 subjected to address port translation as communication data 700 in FIG. 7 to guest OS 16 via virtual network 13-2 (step 211).

Next, suppose guest OS 16 has transmitted communication data 800 in the format of FIG. 8 to NAPT 14-2 via virtual network 13-2 to respond to, for example, communication data 700 (step 212). Communication data 800 includes an IP header 801, a TCP header 802, and a TCP payload 803. IP header 801 is composed of a destination IP address and a source IP address. The IP address of communication device 24 is used as the destination IP address of IP header 801. The private address of guest OS 16 is used as the source IP address of IP header 801. The port number of communication device 24 is used as the destination port number of TCP header 802. The port number used by guest OS 16 is used as the source port number of TCP header 802.

NAPT 14-2 receives communication data 800 from guest OS 16. Then, NAPT 14-2 translates the source IP address and source port number on the basis of its own migration source address table 127 (see FIG. 11) (step 213). In this step, the source IP address of IP header 801 included in communication data 800 is translated from the private address of guest OS 16 into the global address of NAPT 14-1 as shown by arrow 811 in FIG. 8. Moreover, the source port number of TCP header 802 included in communication data 800 is translated from the port number used by guest OS 16 into the port number allocated to guest OS 16 by NAPT 14-1 as shown by arrow 812 in FIG. 8. NAPT 14-2 transmits communication data 800 subjected to address port translation as communication data 810 in FIG. 8 to communication device 24 via LAN 21 (step S214). That is, NAPT 14-2, instead of NAPT 14-1, transmits communication data 800 directly to communication device 24.

With the embodiment, in an environment where NAPT 14-1 and NAPT 14-2 are connected to virtual networks 13-1 and 13-2, respectively, guest OS 16 migrates between virtual machine monitor 12-1 (NAPT 14-1) on hardware unit 11-1 and virtual machine monitor 12-2 (NAPT 14-2) on hardware unit 11-2. As described above, even if guest OS 16 migrates between virtual machine monitors on different hardware units, the global address to be used is the same for communication device 24 on LAN 21 as before the migration of guest OS 16. Therefore, the communication between the migrated guest OS 16 and communication device 24 goes on without interruption and therefore the communication can be performed as before the migration of guest OS 17. Moreover, communication data addressed to communication device 24 transmitted from guest OS 16 migrated from the NAPT 14-1 side to NAPT 14-2 side is transmitted directly to communication device 24 by NAPT 14-2 (that is, migration destination NAPT 14-2) without being relayed between NAPT 14-2 and NAPT 14-1. Accordingly, the load on LAN 21 (i.e., global network) can be alleviated.

<Configuration of Virtual Machine Monitor>

Next, the configuration of virtual machine monitor 12-i (i=1, 2) shown in FIG. 1 will be explained. FIG. 9 is a block diagram showing a configuration of virtual machine monitor 12-i. Virtual machine monitor 12-i (#1) has not only a virtual network 13-i and an NAPT 14-i but also an input/output controller (I/O controller) 121 and a guest OS controller 122. I/O controller 121 is a module which controls various inputs/outputs performed by guest OS 16 including memory access, a disk input/output and a communication data input/output. I/O controller 121 controls NAPT 14-i in such a manner that all the communication data exchanged between hardware unit 11-i and guest OS 16 never fail to be relayed via a communication data determination module 124 explained later in NAPT 14-i. Guest OS controller 122 is a module which controls the start/stop of guest OS 16, the migration of guest OS 16 from virtual machine monitor 12-i to another virtual machine monitor, and the migration of guest OS 16 from another virtual machine monitor to virtual machine monitor 12-i.

NAPT 14-i has not only the function of doing address port translation as normal NAPT has but also the function of transferring communication data from guest OS 16 to NAPT on another virtual machine monitor according to the migration state of guest OS 16. NAPT 14-i includes a guest OS status reception module 123, a communication data determination module 124, a communication data transmission module 125, a migration destination address table 126, a migration source address table 127, an address port translation table 128, and a routing table 129. Tables 126 to 129 are stored in a storage module 130. Storage module 130 is realized by using, for example, the storage area of the memory the hardware unit 11-i has. Although not explained in the embodiment, the data in each entry of tables 126 to 129 may be deleted by periodic monitoring performed by NAPT 14-i after a specific length of time has passed.

Migration destination address table 126 is used to manage migration destination information included in information on the migration of the guest OS controlled by guest OS controller 122. The migration destination information is associated with information on the guest OS (guest OS information) in the table 126. In the embodiment, the global address (IP address) of NAPT on a virtual machine monitor at the migration destination of the guest OS is used as the migration destination information (hereinafter, referred to as migration destination global address information). The private address (IP address) of the guest OS is used as the guest OS information (or private address information). When guest OS status reception module 123 has received a notice that the guest OS has migrated to another virtual machine monitor, the module 123 enters information in the table 126.

FIG. 10 shows a data structure of migration destination address table 126. In the example of FIG. 10, a pair of the private address (IP address) of the guest OS and the global address (IP address) of NAPT on a virtual machine monitor at the migration destination of the guest OS is entered in each entry of migration destination address table 126.

Migration source address table 127 is used to manage migration source information included in information on the migration of the guest OS controlled by guest OS controller 122. The migration source information is associated with information on the guest OS (guest OS information) in the table 127. A pair of the global address (IP address) of the NAPT on the virtual machine monitor at the migration source of the guest OS and the port number allocated to the guest OS by the NAPT on the virtual machine monitor at the migration source is used as migration source information (migration source global address information). A pair of the private address (IP address) of the guest OS and the port number used by the guest OS is used as guest OS information (private address information). When guest OS status reception module 123 has received a notice that the guest OS has migrated from another virtual machine monitor, the module 123 enters information in the table 127.

FIG. 11 shows a data structure of migration source address table 127. In the example of FIG. 11, a pair of the private address (IP address) of the guest OS and the port number used by the guest OS is entered as private address information in each entry of migration source address table 127. Further in each entry of migration source address table 127, a pair of the global address (IP address) of the NAPT on the virtual machine monitor at the migration source of the guest OS and the port number allocated to the guest OS by the NAPT on the virtual machine monitor at the migration source is entered as global address information.

Address port translation table 128 corresponds to a conventional address port translation table provided in a NAPT. Address port translation table 128 is used for translation between private address information and global address information. Private address information is composed of a pair of the private address of the guest OS and the port number used by the guest OS. Global address information is composed of a pair of the global address of NAPT 14-i on virtual machine monitor 12-i allocating a port number to the guest OS (that is, virtual machine monitor 12-i on which the guest OS operates) and the port number allocated to the guest OS.

Guest OS status reception module 123 enters information in address port translation table 128, for example, when a private network (here, virtual network 13-i) has established communication with an external network (here, LAN 21), or when the module 123 has received a request such as a well-known NAPT-PMP protocol (http://files.dns-sd.org/draft-cheshire-nat-pmp.txt) for port allocation. Here, suppose the port number in the global address information allocated to the guest OS is set so that it may be unique in NAPT 14-i on virtual network 13-i included in a range to which the guest OS might be migrated.

FIG. 12 shows a data structure of the address port translation table (hereinafter, referred to as the translation table) 128. In the example of FIG. 12, not only is a pair of the private address (IP address) of the guest OS and the port number used by the guest OS entered as private address information in each entry of translation table 128, but also a pair of the global address (IP address) of NAPT 14-i and the port number allocated to the guest OS by NAPT 14-i is entered as global address information in each entry of translation table 128. Routing table 129 corresponds to a conventional routing table provided in each of the NAPT and router. Since the data structure of routing table 129 is well known, an explanation thereof will be omitted.

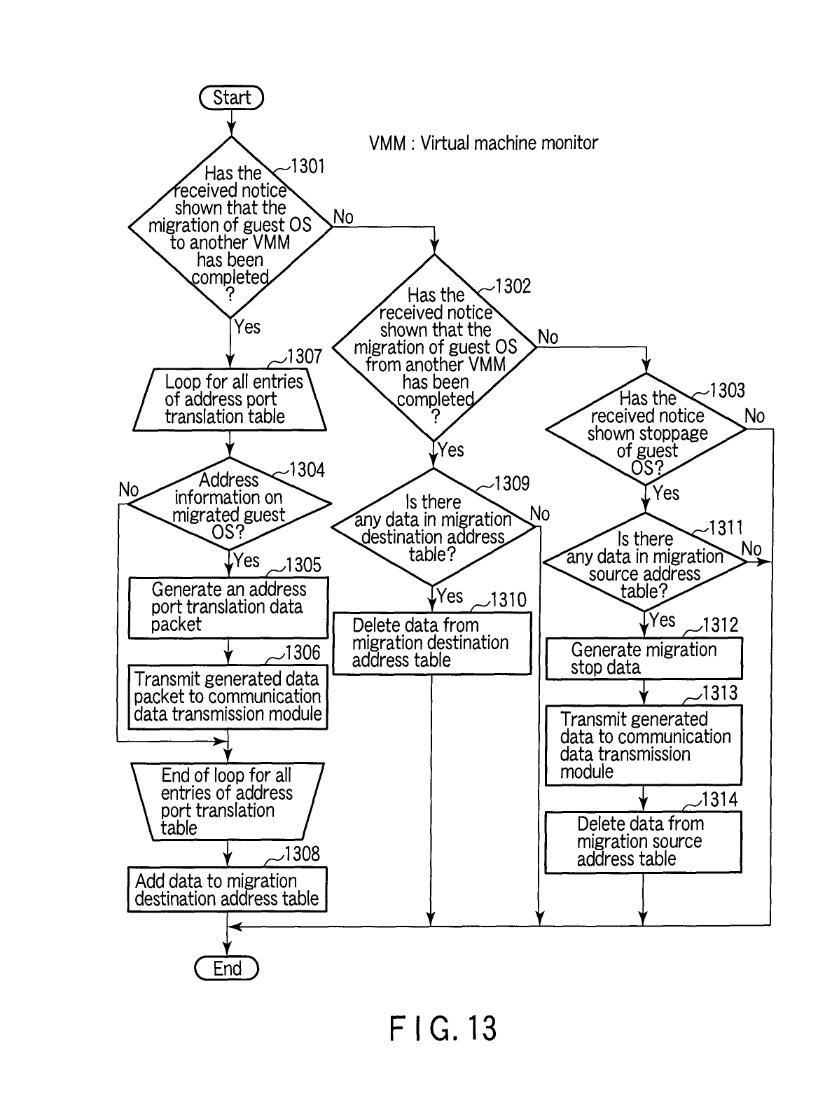

Next, the operation of guest OS status reception module (hereinafter, referred to as reception module) 123 in NAPT 14-i will be explained with reference to a flowchart in FIG. 13. Reception module 123 receives a notice of the status of the guest OS from guest OS controller 122 of virtual machine monitor 12-i and carries out a process according to the contents of the notice as follows.

(1) Operation when the Migration of the Guest OS to Another Virtual Machine Monitor has been Completed

First, suppose guest OS 16 on virtual machine monitor (VMM) 12-i has been migrated to another virtual machine monitor (VMM). The following is an explanation of the process performed by reception module 123 when, as a result of the migration, guest OS controller 122 of virtual machine monitor 12-i has notified NAPT 14-i that the migration of the guest OS to another virtual machine monitor has been completed.

When guest OS controller 122 has notified NAPT 14-i of the status of the guest OS, reception module 123 receives the notice. Then, reception module 123 determines the contents of the received notice (steps 1301 to 1303). If the received notice has shown that the migration of the guest OS from virtual machine monitor 12-i to another virtual machine monitor has been completed (YES in step 1301) as described above, reception module 123 performs subsequent steps 1304 to 1306 on the data items in all the entries of translation table 128 repeatedly (step 1307).

In step 1304, reception module 123 determines whether the address (private address) of the migrated guest OS coincides with the private address in the data, on the basis of the data entered in a target entry of translation table 128. If the former coincides with the latter (YES in step 1304), reception module 123 generates address port translation data in the same format as that of translation data 500 shown in FIG. 5 (step 1305). The data held in the entry of the translation table 128 including the private address coinciding with the address (private address) of the migrated guest OS is used to generate the address port translation data. Reception module 123 sends the generated address port translation data to communication data transmission module (hereinafter, referred to as transmission module) 125 (step 1306). If the private address of the migrated guest OS does not coincide with the private address in the data (NO in step 1304), reception module 123 skips steps 1305 and 1306.

Reception module 123 performs the above processes on the data in all the entries of translation table 128 repeatedly (step 1307). Thereafter, reception module 123 functions as a migration destination address table data addition module. Then, reception module 123 additionally enters data (migration destination address table data) in an empty entry of migration destination address table 126 (step 1308) and terminates the process. The migration destination address table data includes the private address of guest OS 16 migrated to another virtual machine monitor and the global address of the NAPT (migration destination NAPT) on the virtual machine monitor at the migration destination.

(2) Operation when the Migration of the Guest OS from Another Virtual Machine Monitor has been Completed

Next, suppose guest OS 16 has been migrated from another virtual machine monitor to virtual machine monitor 12-i. Suppose, as a result of the migration, guest OS controller 122 of virtual machine monitor 12-i notifies NAPT 14-i that the migration of the guest OS from another virtual machine monitor has been completed. The notice is received by reception module 123. If the received notice has shown the migration of guest OS 16 from another virtual machine monitor to virtual machine monitor 12-i including the reception module 123 has been completed (YES in step 1302), reception module 123 proceeds to step 1309. In step 1309, the reception module 123 determines whether the private address (more precisely, data on the migration destination including the private address) of guest OS 16 (i.e., the migrated guest OS 16) has been entered (or exists) in migration destination address table 126 (step 1309).

If the private address of the migrated guest OS 16 has been entered in the migration destination address table 126 (YES in step 1309), reception module 123 has determined that guest OS 16 has migrated from virtual machine monitor 12-i to another virtual machine monitor and then returned to virtual machine monitor 12-i. In this case, reception module 123 deletes data on the migration destination of guest OS 16 returned to virtual machine monitor 12-i from the corresponding entry of migration destination address table 126 (step 1310) and terminates the process. If the private address of migrated guest OS 16 has not been entered in migration destination address table 126 (NO in step 1309), reception module 123 skips step 1310 and terminates the process.

(3) Operation when the Guest OS has Stopped

Next, suppose guest OS 16 operating on virtual machine monitor 12-i has stopped. As a result of the stoppage, guest OS controller 122 of virtual machine monitor 12-i notifies NAPT 14-i of the stoppage of guest OS 16 and reception module 123 has received the notice. If the received notice has shown the stoppage of guest OS 16 (YES in step 1303), reception module 123 proceeds to step 1311. In step 1311, the reception module 123 determines whether the private address of the stopped guest OS 16 (or migration source data including the private address) has been entered in migration source address table 127 (step 1311).

If the private address of the stopped guest OS 16 has been entered in migration source address table 127 (YES in step 1311), reception module 123 determines that the migration source virtual machine monitor has to be notified of the completion of the migration to stop the transfer of communication data. Then, reception module 123 generates migration stop data addressed to the global address of the migration source NAPT on the basis of the global address of NAPT (migration source NAPT) on the migration source virtual machine monitor entered in migration source address table 127 in such a manner that the migration stop data is caused to correspond to the private address of the stopped guest OS 16 (step 1312). The migration stop data (migration stop data packet) will be described later.

The reception module 123 sends the generated migration stop data to transmission module 125, thereby causing transmission module 125 to transmit the migration stop data (via I/O controller 121) to the migration source virtual machine (step 1313). Finally, reception module 123 deletes information on the stopped guest OS 16 from the corresponding entry of migration source address table 127 (step 1314) and terminates the process.

<Migration Stop Data>

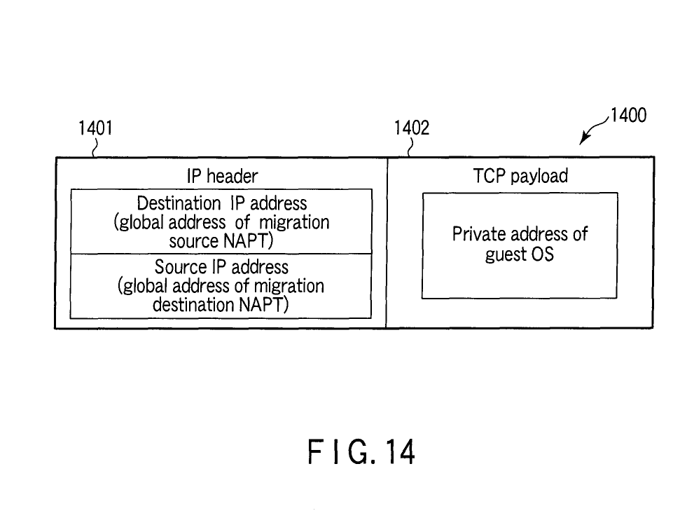

FIG. 14 shows a format of the migration stop data. In FIG. 14, migration stop data 1400 includes an IP header 1401 and an IP payload 1402. The global address of the migration source NAPT is used as the destination IP address of IP header 1401. The global address of the migration destination NAPT is used as the source IP address of IP header 1401. Data set in IP payload 1402 includes the private address of the guest OS to be stopped. The private address of the guest OS to be stopped may be set in a TCP payload. That is, the migration stop data may be any communication data, provided that the communication data uses the global address of the migration source NAPT as a destination IP address and the global address of the migration destination NAPT as a source IP address, includes the private address of the stopped guest OS in its data part, and can be identified as migration stop data.

<Operation of Communication Data Determination Module>

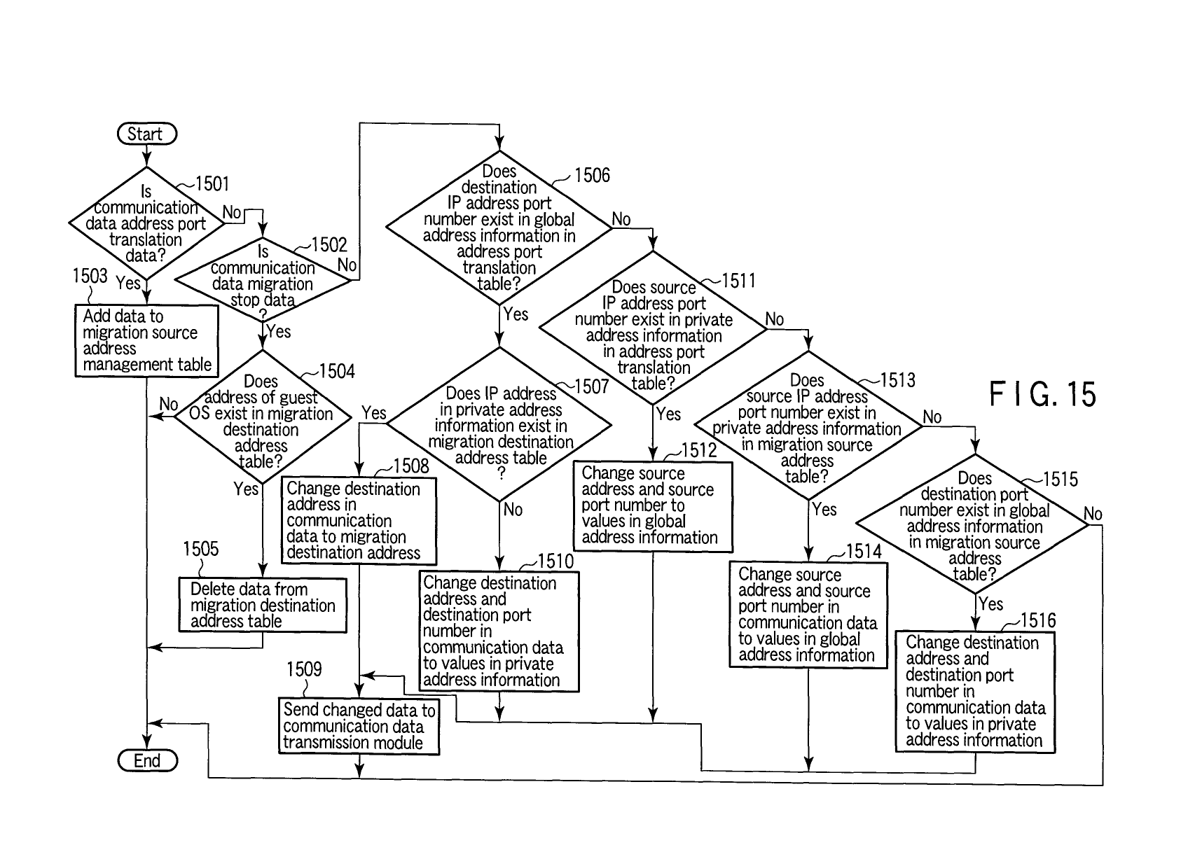

Next, the operation of communication data determination module (hereinafter, referred to as determination module) 124 will be explained with reference to a flowchart in FIG. 15. In the embodiment, I/O controller 121 of virtual machine monitor 12-i inputs all the communication data items passing through the controller 121 to determination module 124 of NAPT 14-i, thereby causing all the communication data items to pass through determination module 124. Determination module 124 carries out a process according to the type of communication data input by I/O controller 121. First, determination module 124 functions as a detection module and determines whether the communication data input by I/O controller 121 is address port translation data (address port translation packet), migration stop data, or anything else (steps 1501 and 1502).

If the input communication data of FIG. 5 is address port translation data in the same format as that of address port translation data 500 shown in FIG. 5 (YES in step 1501), determination module 124 determines that the guest OS (virtual machine) has been migrated from another NAPT to NAPT 14-2 including determination module 124 (the private address space of NAPT 14-2). That is, determination module 124 of NAPT 14-i receives address port translation data from one other NAPT via I/O controller 121, thereby detecting the migration of the guest OS from the one other NAPT. In this case, determination module 124, which functions as an address port translation data addition module, adds the contents of the received address port translation data (the contents of the IP payload) to migration source address table 127 (step 1503) and terminates the process.

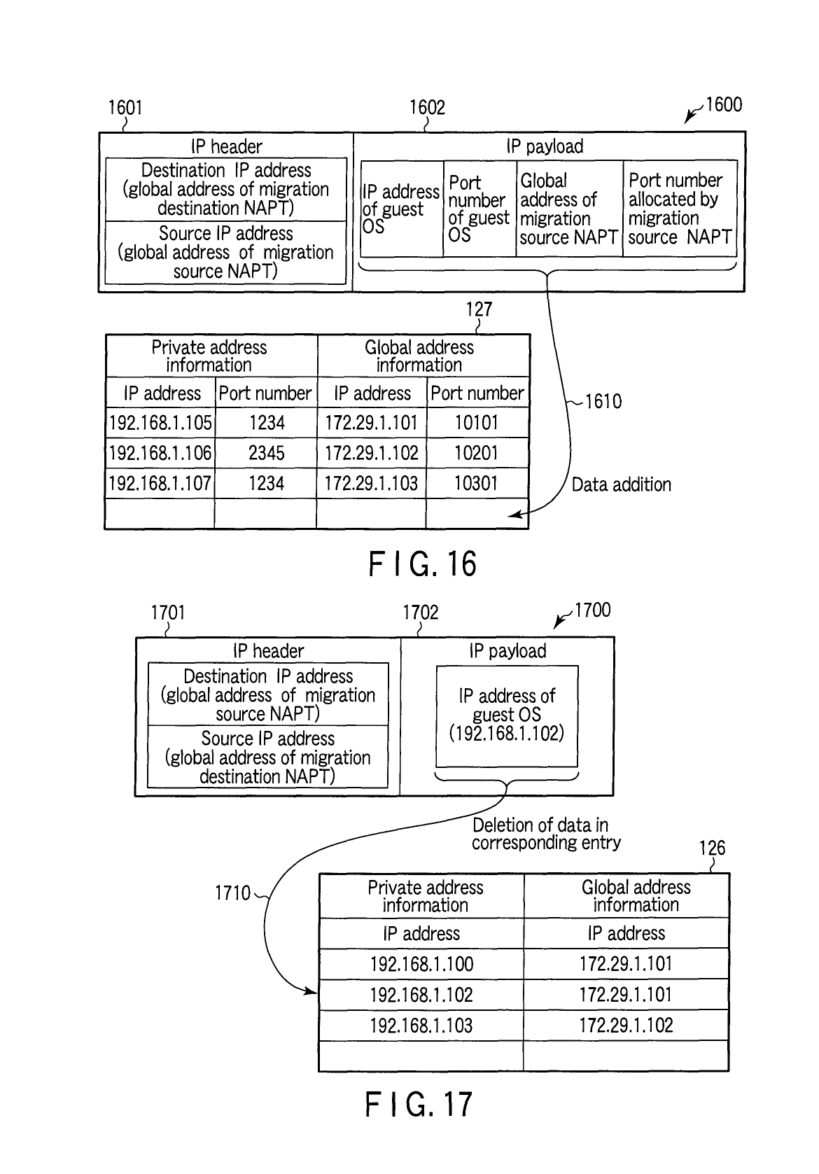

FIG. 16 is a diagram to explain the operation of step 1503. In FIG. 16, address port translation data 1600, the input communication data, includes an IP header 1601 and an IP payload 1602. The global address of the migration destination NAPT is set as the destination IP address of header 1601. The global address of the migration source NAPT is set as the source IP address of IP header 1601. IP payload 1602 includes the private address (IP address) of the guest OS, the port number of the guest OS (the port number used by the guest OS), the global address of the migration source NAPT, and the port number allocated to the guest OS by the migration source NAPT.

In step 1503, the contents of IP payload 1602 in address port translation data 1600, that is, the private address (IP address) of the guest OS, the port number of the guest OS, the global address of the migration source NAPT, and the port number allocated to the guest OS by the migration source NAPT are added (or entered) to an empty entry of migration source address table 127 as shown by arrow 1610 in FIG. 16. As a result, NAPT 14-i (migration destination NAPT 14-i) including determination module 124 shares address port translation data managed by the migration source NAPT with the migration source NAPT. More specifically, migration destination NAPT 14-i shares address port translation data managed by the migration source NAPT using translation table 128 the migration source NAPT has with the migration source NAPT on the basis of migration source address table 127 the migration source NAPT has.

On the other hand, if the input communication data is migration stop data in the same format as that of migration stop data 1400 shown in FIG. 14 (NO in step 1501 and YES in step 1502), determination module 124 determines that the guest OS has stopped at the migration destination. In this case, determination module 124 determines whether the IP address (private address) of the guest OS included in the IP payload of the input migration stop data has been entered in migration destination address table 127 (step 1504). If the result of the determination in step 1504 is YES, determination module 124 deletes the data in the entry of migration destination address table 126 in which the IP address of the guest OS included in the IP payload of the input migration stop data (step 1505) and terminates the process. In contrast, if the result of the determination in step 1504 is NO, determination module 124 skips step 1505 and terminates the process.

FIG. 17 is a diagram to explain the operation of step 1505. In FIG. 17, migration stop data 1700, the input communication data, includes an IP header 1701 and an IP payload 1702. The global address of the migration source NAPT is set as the destination IP address of IP header 1701. The global address of the migration destination NAPT is set as the source IP address of IP header 1701. IP payload 1702 includes the IP address (private address) “192.168.1.102” of the guest OS.

In the example of FIG. 17, the IP address “192.168.1.102” of the guest OS has been entered in migration destination address table 126 (YES in step 1504). In step 1505, the data in the entry of migration destination address table 126 in which the IP address “192.168.1.102” of the guest OS set in IP payload 1702 of migration stop data 1700 has been entered is deleted from the table 126 as shown by arrow 1710 in FIG. 17.

Next, suppose the input communication data is neither address port translation data nor migration stop data (NO in step 1501 and NO in step 1502). In this case, determination module 124 determines whether the destination IP address and destination port number included in the IP header and TCP header of the input communication data, respectively, are included in the global address information in translation table 128 (that is, the destination IP address and destination port number coincide with the IP address and port number in the global address information) (step 1506).

If the result of the determination in step 1506 is YES, determination module 124 determines that the input communication data is communication data addressed to the guest OS. In this case, determination module 124 functions as a first determination module. Then, determination module 124 executes step 1507 to determine whether the relevant guest OS (that is, the guest OS specified by the destination IP address in the input communication data) has migrated. In step 1507, determination module 124 refers to the entry of translation table 128 in which the global address information determined in step 1506 (that is, global address information including the destination IP address and destination port number in the input communication data) has been entered. Then, determination module 124 determines whether the IP address (the private address of the guest OS) in the private address information held in the entry referred to has been entered in migration destination address table 126.

If the result of the determination in step 1507 is YES, determination module 124 determines that the relevant guest OS has migrated. Then, determination module 124 changes (or translates) the destination IP address in the input communication data to the IP address (the global address of the migration destination NAPT) in the migration destination global address information set in the entry of translation table 128 used in the determination in step 1507 (step 1508). The change of the destination IP address in step 1508 corresponds to the translation of communication data 600 into communication data 610 in FIG. 6. Determination module 124 sends the communication data with the changed destination address, that is, the communication data translated so as to be addressed to the migration destination NAPT, to transmission module 125 (step 1509) and terminates the process. Transmission module 125 transfers the communication data translated so as to be addressed to the migration destination NAPT to the migration destination NAPT.

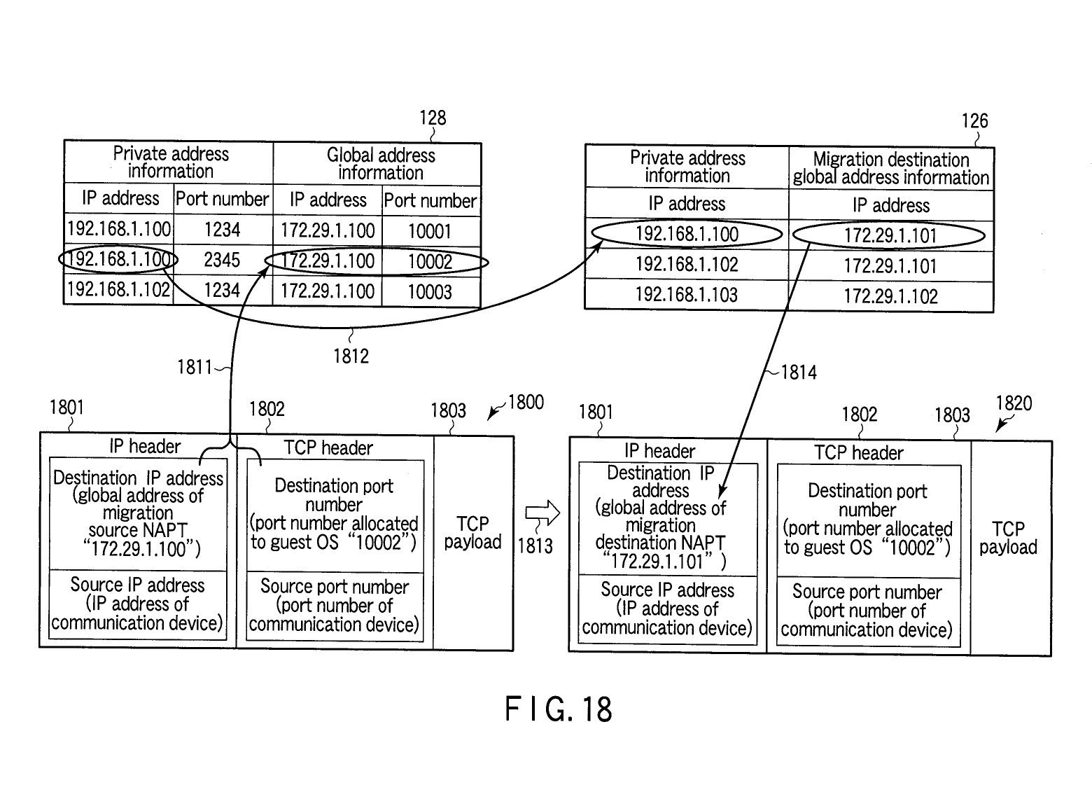

FIG. 18 is a diagram to explain the operation of step 1508. In FIG. 18, the input communication data 1800 includes an IP header 1801, a TCP header 1802, and a TCP payload 1803. The global address “172.29.1.100” of the migration source NAPT is set as the destination IP address of IP header 1801. The IP address of the communication device is set as the source IP address of IP header 1801. The port number “10002” allocated to the guest OS by the migration source NAPT is set as the destination port number of TCP header 1802. The port number of the communication device is set as the source port number of TCP header 1802.

In the example of FIG. 18, a pair of the destination IP address of communication data 1800 (the global address “172.29.1.100” of the migration source NAPT) and the destination port number of communication data 1800 (the port number “10002” allocated to the guest OS by the migration source NAPT) has been entered as global address information in translation table 128 as shown by arrow 1811 (YES in step 1506). Moreover, in an entry of the translation table in which the global address information has been entered, private address information has also been entered. The IP address (private address of the guest OS) “192.168.1.100” included in the private address information has been entered as (the IP address of) private address information in migration destination address table 126 as shown by arrow 1812 (YES in step 1507). In the example of FIG. 18, step 1508 is executed.

As a result, communication data 1800 is translated into new communication data 1820 by changing the destination IP address of communication data 1800 as shown by arrow 1813. That is, the destination IP address of communication data 1800 is changed from the global address “172.29.1.100” of the migration source NAPT to the IP address (i.e., the global address of the migration destination NAPT) “172.29.1.101” as shown by arrow 1814. The IP address “172.29.1.101” is the IP address in the migration destination global address information which has been paired with the IP address “192.168.1.100” in the private address information and entered in an entry of migration destination address table 126. In FIG. 18, the changed communication data 1800 is shown as communication data 1820.

On the other hand, if the result of the determination in step 1507 is NO, determination module 124 determines that the relevant guest OS has not migrated. In this case, determination module 124 carries out a known operation of NAPT. That is, determination module 124 changes the destination IP address and destination port number in the input communication data to the values in the private address information which has been paired with the global address information including the destination IP address and destination port number and entered in an entry of translation table 128 (step 1510). The change of the destination IP address and destination port number in step 1510 corresponds to the change of communication data 300 to communication data 310 in FIG. 3 (step 202 of FIG. 1). Determination module 124 sends the communication data with the changed destination IP address and destination port number, that is, the communication data translated so as to be addressed to the guest OS (the guest OS not migrated) to transmission module 125 (step 1509) and terminates the process. Transmission module 125 sends the communication data translated so as to be addressed to the guest OS to the guest OS.

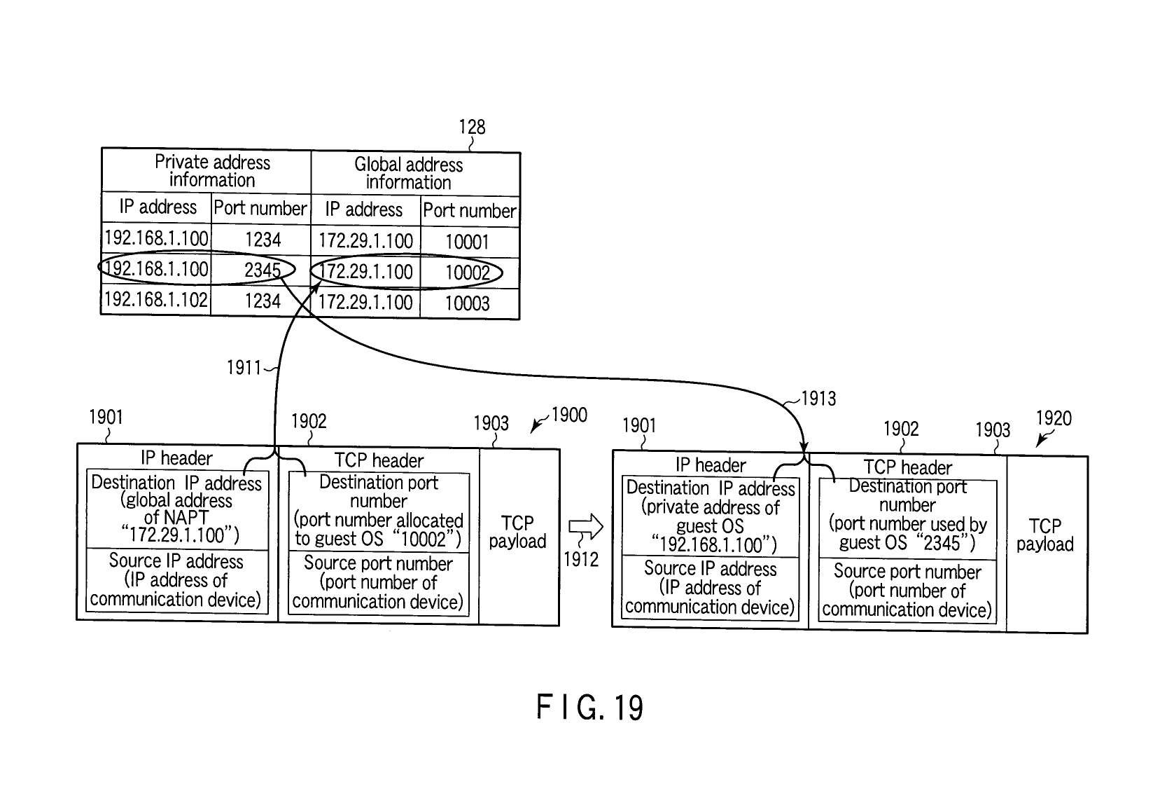

FIG. 19 is a diagram to explain the operation of step 1510. In FIG. 19, the input communication data 1900 includes an IP header 1901, a TCP header 1902, and a TCP payload 1903. The global address “172.29.1.100” of NAPT is set as the destination IP address of IP header 1901. The IP address of the communication device is set as the source IP address of IP header 1901. The port number “10002” allocated to the guest OS by a NAPT with the global address shown by the destination IP address is set as the destination port number of TCP header 1902. The port number of the communication device is set as the source port number of TCP header 1902.

In the example of FIG. 19, a pair of the destination IP address of communication data 1900 (the global address “172.29.1.100” of NAPT) and the destination port number of communication data 1900 (the port number “10002” allocated to the guest OS) has been entered as global address information in translation table 128 as shown by arrow 1911 (YES in step 1506). Suppose the IP address (the private address of the guest OS) “192.168.1.100” in the private address information paired with the global address information and entered in an entry of translation table 128 has not been entered as (the IP address of) private address information in migration destination address table 126 (NO in step 1507). In the example of FIG. 19, step 1510 is executed.

As a result, communication data 1900 is translated into new communication data 1920 by changing the destination IP address and destination port number of communication data 1900 as shown by arrow 1912. That is, the destination IP address and destination port number of communication data 1900 are changed from the global address “172.29.1.100” of NAPT and the port number “1002” allocated to the guest OS to the IP address (the private address of the guest OS) “192.168.1.100” and the port number (the port number used by the guest OS) “2345” as shown by arrow 1913. The changed IP address “192.168.1.100” and port number “2345” are included in the private address information which has been paired with the global address information (global address “172.29.1.100” and port number “10002”) and entered in an entry of translation table 128. In FIG. 19, the changed communication data 1900 is shown as communication data 1920.

On the other hand, if the result of the determination in step 1506 is NO, determination module 124 functions as a second determination module. Then, determination module 124 determines whether the source IP address and source port number included in the IP header and TCP header in the input communication data, respectively, are included in the private address information entered in translation table 128 (that is, coincide with the IP address and port number in the private address information) (step 1511).

If the result of the determination in step 1511 is YES, determination module 124 determines that the input communication data is the communication data transmitted by the guest OS. Then, determination module 124 changes the source IP address and source port number in the input communication data to the IP address (the global address of NAPT) and port number (the port number allocated to the guest OS) in the global address information set in an entry of translation table 128 used in the determination in step 1511 (step 1512). The change of the source IP address and source port number in step 1512 corresponds to the change of communication data 400 to communication data 410 in FIG. 4 (step 205 in FIG. 1). Determination module 124 sends the communication data with the changed source IP address and source port number to transmission module 125 (step 1509) and terminates the process. Transmission module 125 transfers the communication data to the communication device.

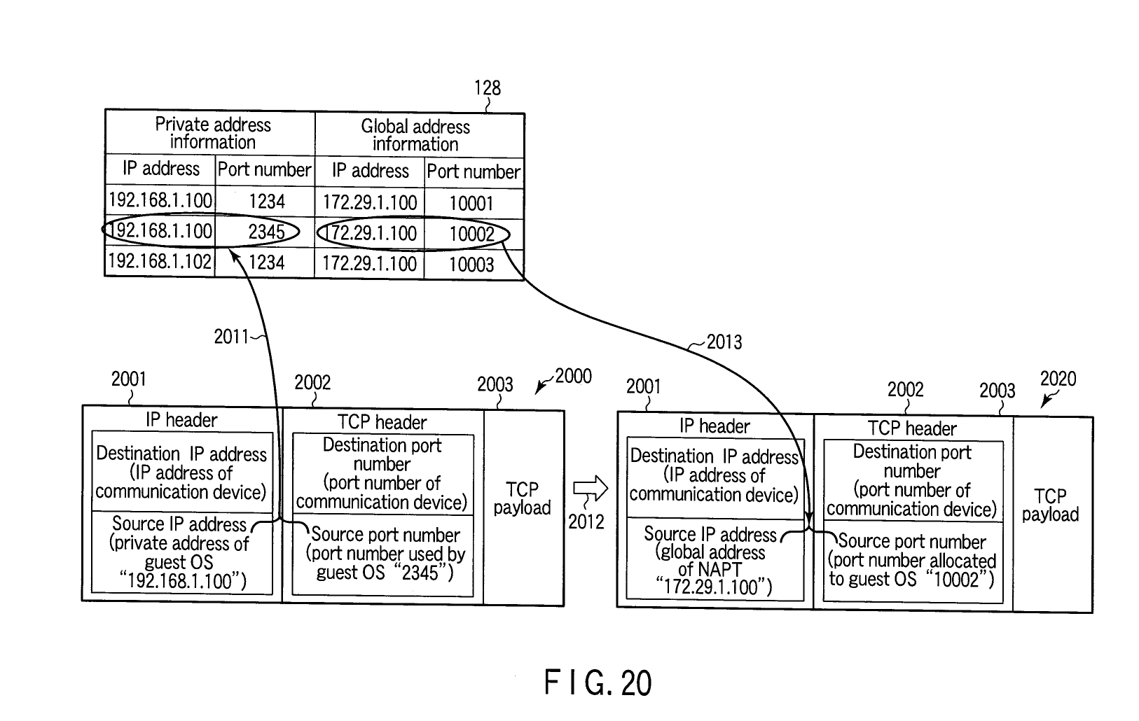

FIG. 20 is a diagram to explain the operation of step 1512. In FIG. 20, the input communication data 2000 includes an IP header 2001, a TCP header 2002, and a TCP payload 2003. The IP address of the communication device is set as the destination IP address of IP header 2001. The private address (IP address) “192.168.1.100” the guest OS has is set as the source IP address of IP header 2001. The port number of the communication device is set as the destination port number of TCP header 2002. The port number “2345” used by the guest OS is set as the source port number of TCP header 2002.

In the example of FIG. 20, a pair of the source IP address of communication data 2000 (the private address “192.168.1.100” the guest OS has) and the source port number of communication data 2000 (the port number “2345” used by the guest OS) has been entered as private address information in translation table 128 as shown by arrow 2011 (YES in step 1511). In this case, step 1512 is executed. As a result, communication data 2000 is translated into new communication data 2020 by changing the source IP address and source port number in communication data 2000 as shown by arrow 2012.

Specifically, the source IP address and source port number in communication data 2000 are changed from the private address (IP address) “192.168.1.100” the guest OS has and the port number “2345” used by the guest OS to the IP address (the global address of NAPT) “172.29.1.100” and port number (the port number allocated to the guest OS) “10002” as shown by arrow 2013. The changed IP address “172.29.1.100” and port number “10002” are included in global address information which has been paired with the private address information (private address “192.168.1.100” and port number “2345”) and entered in an entry of translation table 128. In FIG. 20, the changed communication data 2000 is shown as communication data 2020.

On the other hand, if the result of the determination in step 1511 is NO, determination module 124 functions as a third determination module. Then, determination module 124 determines whether the source IP address and source port number included in the IP header and TCP header, respectively, in the input communication data, are included in the private address information in migration source translation table 127 (that is, coincide with the IP address and port number in the private address information) (step 1513).

If the result of the determination in step 1513 is YES, determination module 124 determines that the input communication data is communication data transmitted from the guest OS migrated from another virtual machine monitor. Then, determination module 124 changes the source IP address and source port number in the input communication data to the IP address (the global address of the migration source NAPT) and port number (the port number allocated to the guest OS) in the global address information set in an entry of migration source address table 127 used in the determination in step 1513 (step 1514). In this way, the source IP address and source port number in the communication data are changed to the IP address and port number in the global address information included in the address port translation data shared with the migration source NAPT. The change of the source IP address and source port number in step 1514 corresponds to the change of communication data 800 to communication data 810 in FIG. 8 (step 213 in FIG. 1). Determination module 124 sends the communication data with the changed source IP address and source port number to transmission module 125 (step 1509) and terminates the process. Transmission module 125 transfers the communication data to the communication device.

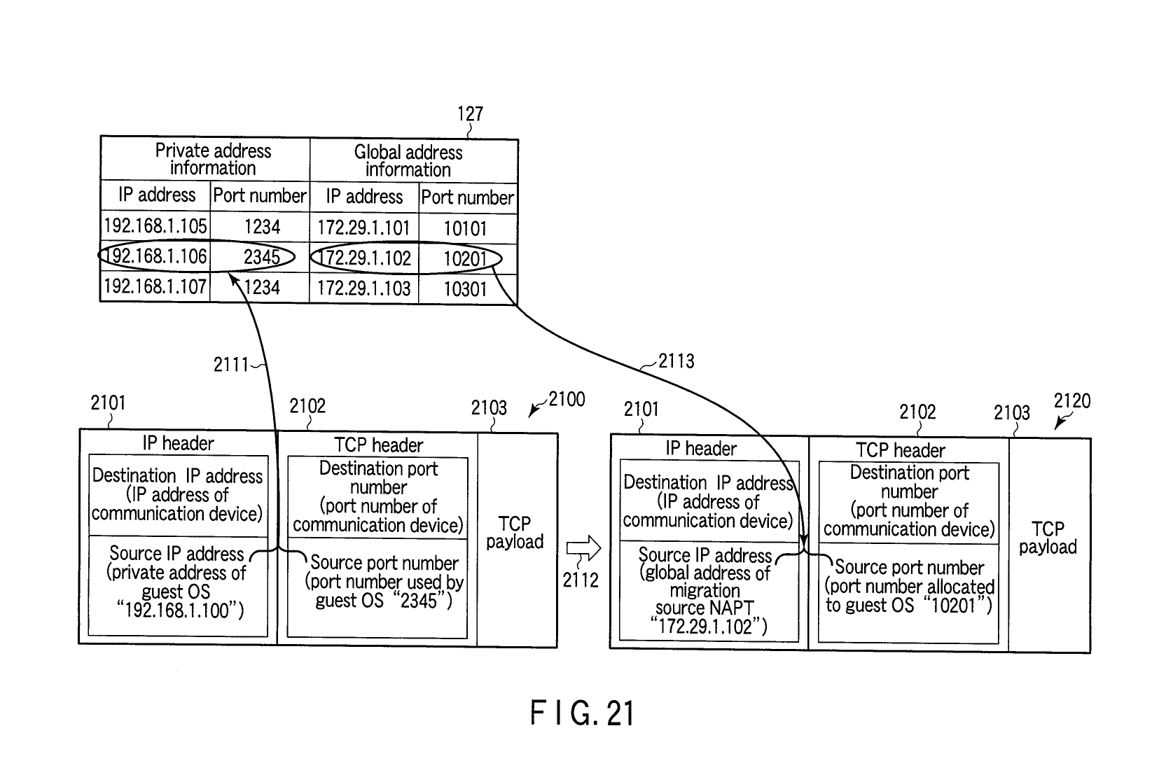

FIG. 21 is a diagram to explain the operation of step 1514. In FIG. 21, the input communication data 2100 includes an IP header 2101, a TCP header 2102, and a TCP payload 2103. The IP address of the communication device is set as the destination IP address of IP header 2101. The private address (IP address) “192.168.1.106” the guest OS has is set as the source IP address of IP header 2101. The port number of the communication device is set as the destination port number of TCP header 2102. The port number “2345” used by the guest OS is set as the source port number of TCP header 2102.

In the example of FIG. 21, a pair of the source IP address of communication data 2100 (the private address “192.168.1.106” the guest OS has) and the source port number of communication data 2100 (the port number “2345” used by the guest OS) has been entered as private address information in migration source address table 127 as shown by arrow 2111 (YES in step 1513). In this case, step 1514 is executed. As a result, communication data 2100 is translated into new communication data 2120 by changing the source IP address and source port number in communication data 2100 as shown by arrow 2112.

Specifically, the source IP address and source port number in communication data 2100 are changed from the private address “192.168.1.106” the guest OS has and the port number “2345” used by the guest OS to the IP address (the global address of the migration source NAPT) “172.29.1.102” and port number (the port number allocated to the guest OS by the migration source NAPT) “10201” as shown by arrow 2113. The changed IP address “172.29.1.102” and port number “10201” are included in the global address information which has been paired with the private address information (private address “192.168.1.106” and port number “2345”) and entered in an entry of migration source table 127. In FIG. 21, the changed communication data 2100 is shown as communication data 2120.

On the other hand, if the result of the determination in step 1513 is NO, determination module 124 functions as a fourth determination module. Then, determination module 124 determines whether the destination port number in the TCP header in the input communication data is included in the global address information in migration address table 127 (that is, coincides with the port number in the global address information) (step 1515).

If the result of the determination in step 1515 is YES, determination module 124 determines that the input communication data is communication data transferred from the NAPT at the migration source of the guest OS. Then, determination module 124 changes the destination IP address and destination port number in the input communication data to the IP address (the private address of the guest OS) and port number (the port number used by the guest OS) in the private address information set in an entry of migration source address table 127 used in the determination in step 1515 (step 1516). In this way, the source IP address and source port number in the communication data are changed to the IP address and port number in the private address information included in the address port translation data shared with the migration source NAPT. The change of the destination IP address and destination port number in step 1516 corresponds to the change of communication data 610 to communication data 700 in FIG. 7. Determination module 124 sends the communication data with the changed destination IP address and destination port number to transmission module 125 (step 1509) and terminates the process. Transmission module 125 transfers the communication data to the guest OS migrated from another virtual machine monitor.

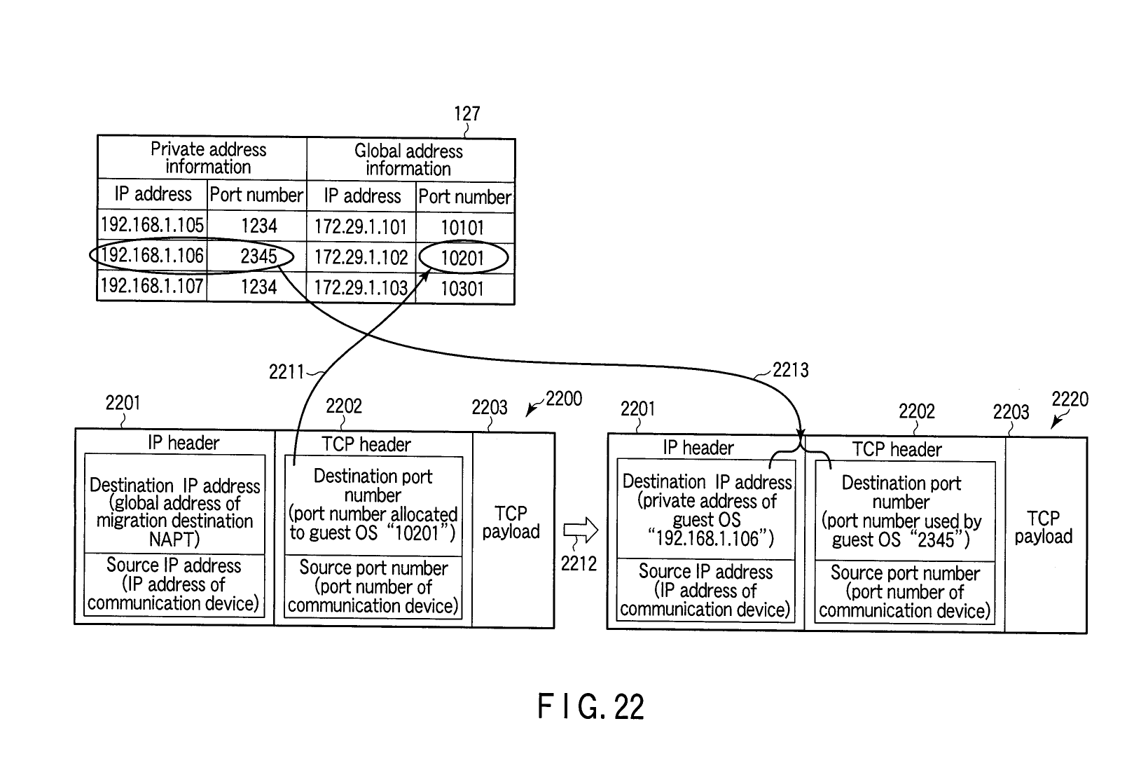

FIG. 22 is a diagram to explain the operation of step 1516. In FIG. 22, the input communication data 2200 includes an IP header 2201, a TCP header 2202, and a TCP payload 2203. The global address of the migration destination NAPT is set as the destination IP address of IP header 2201. The IP address of the communication device is set as the source IP address of IP header 2201. The port number “10201” allocated to the guest OS is set as the destination port number of TCP header 2202. The port number of the communication device is set as the source port number of TCP header 2202.

In the example of FIG. 22, the destination port number of communication data 2200 (the port number “10201” allocated to the guest OS) has been entered as the port number in the global address information in migration source address table 127 as shown by arrow 2211 (YES in step 1513). In this case, step 1516 is executed.

As a result, communication data 2200 is translated into new communication data 2220 by changing the destination IP address and destination port number in communication data 2200 as shown by arrow 2212. Specifically, the destination IP address and destination port number in communication data 2200 are changed from the global address of the migration destination NAPT and the port number “10201” allocated to the guest OS to the IP address (the private address of the guest OS) “192.168.1.106” and port number (the port number used by the guest OS) “2345” as shown by arrow 2213. The changed IP address “192.168.1.106” and port number “2345” are included in the private address information which has been paired with the global address information (global address information including the port number “10201”) and entered in an entry of migration source address table 127. In FIG. 22, the changed communication data 2200 is shown as communication data 2220.

Next, the operation of transmission module 125 will be described briefly. When receiving the communication data sent to transmission module 125, the module 125 operates as a normal NAPT or router does. That is, according to routing table 129, transmission module 125 sends communication data to the interface specified in the table 129. In this case, transmission module 125 sends communication data to either virtual network 13-i on virtual machine monitor 12-i or an interface the hardware unit 11-i has.

[Modification]

Next, a modification of the embodiment will be explained.

<Configuration of Virtual Machine System in Modification>

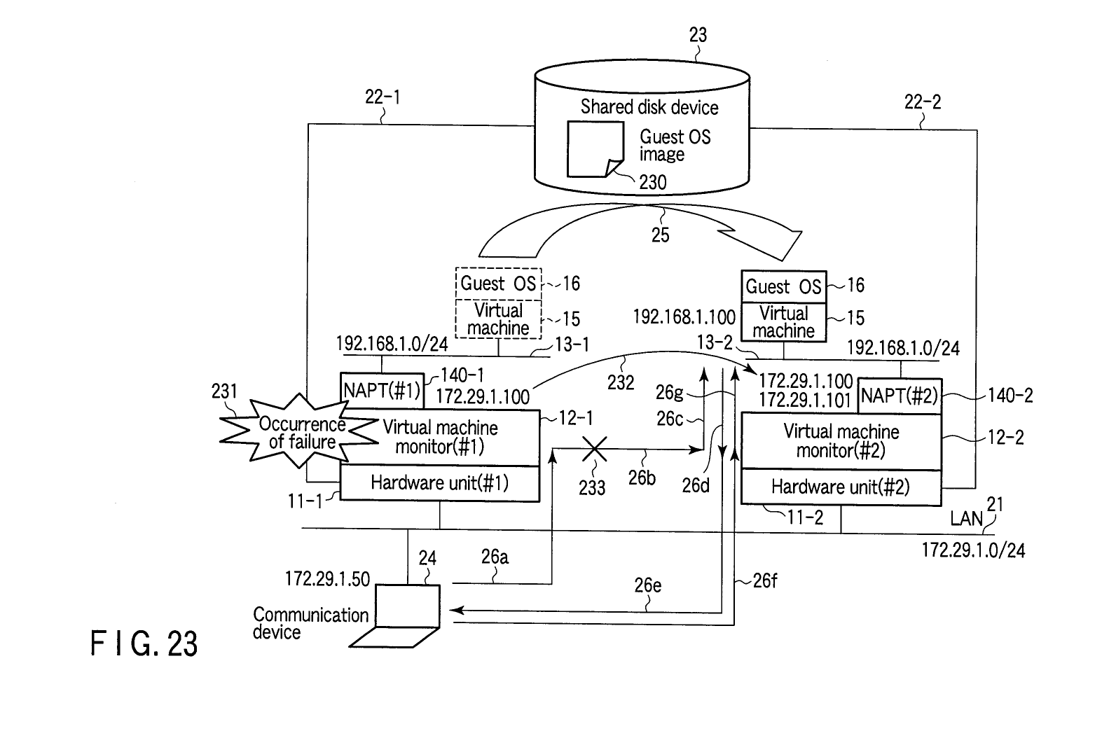

FIG. 23 is a block diagram showing the configuration of a virtual machine system according to a modification of the embodiment. In FIG. 23, the parts equivalent to those of FIG. 1 are indicated by the same reference numerals. The modification is characterized in that NAPT 140-1 and NAPT 140-2 each having the function of detecting a failure in the other are used in place of NAPT 14-1 and NAPT 14-2, respectively. More specifically, the modification is characterized in that, for example, if a failure has occurred in NAPT (migration source NAPT) 140-1 on virtual machine monitor 12-1, the migration source of guest OS 16, NAPT (migration destination NAPT) 140-2 on virtual machine monitor 12-2, the migration destination of guest OS 16, takes over the process of NAPT 140-1 performed on guest OS 16 (the migrated guest OS 16).

The configuration of FIG. 23 differs from that of FIG. 1 in the use of NAPT 140-1 and NAPT 140-2 in place of NAPT 14-1 and NAPT 14-2 and in the communication control procedure of NAPT 140-2 after migration destination NAPT 140-2 has detected the occurrence of a failure in migration source NAPT 140-1. In this modification, when having detected a failure occurrence in NAPT 140-1, NAPT 140-2 takes over the global address (172.29.1.100) of NAPT 140-1 as shown by arrow 232 in FIG. 23. Moreover, NAPT 140-2 takes over the contents of its own migration source address table 127 by incorporating the contents into its own translation table 128. By the takeover, NAPT 140-2 performs a NAPT process on communication data on the migrated guest OS 16 in place of NAPT 140-1 as follows.

NAPT 140-2 stops relaying the communication from communication device 24 to guest OS 16 (the migrated guest OS 16) as shown by x mark 233 in FIG. 23. Then, NAPT 140-2 controls the communication from communication device 24 to guest OS 16 in such a manner that the communication is performed without the intervention of NAPT 140-1 as shown by arrows 26f and 26g in FIG. 23 as is the communication from guest OS 16 to communication device 24 (or the communication shown by arrows 26d and 26e) in the embodiment. Specifically, NAPT 140-2 receives communication data addressed to guest OS 16 which has been sent from communication device 24 and in which the global address of NAPT 140-1 (that is, the global address taken over by NAPT 140-2) has been set as the destination IP address, in place of NAPT 140-1 as shown by arrow 26f. On the basis of translation table 128, NAPT 140-2 translates the destination IP address and destination port number in the received communication data addressed to guest OS 16 into the private address of guest OS 16 and the port number used by guest OS 16. NAPT 140-2 transmits the communication data with the translated destination IP address and destination port number to guest OS 16 via virtual network 13-2 as shown by arrow 26g.

<Communication Sequence Before and After the Occurrence of a Failure in Migration Source NAPT>

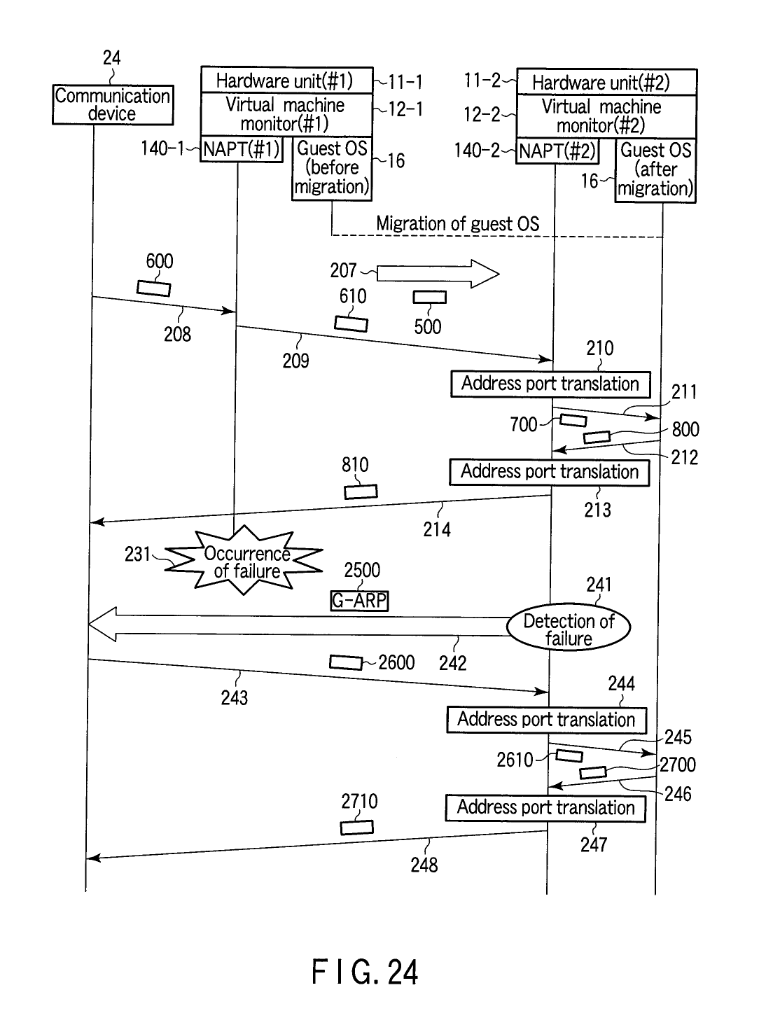

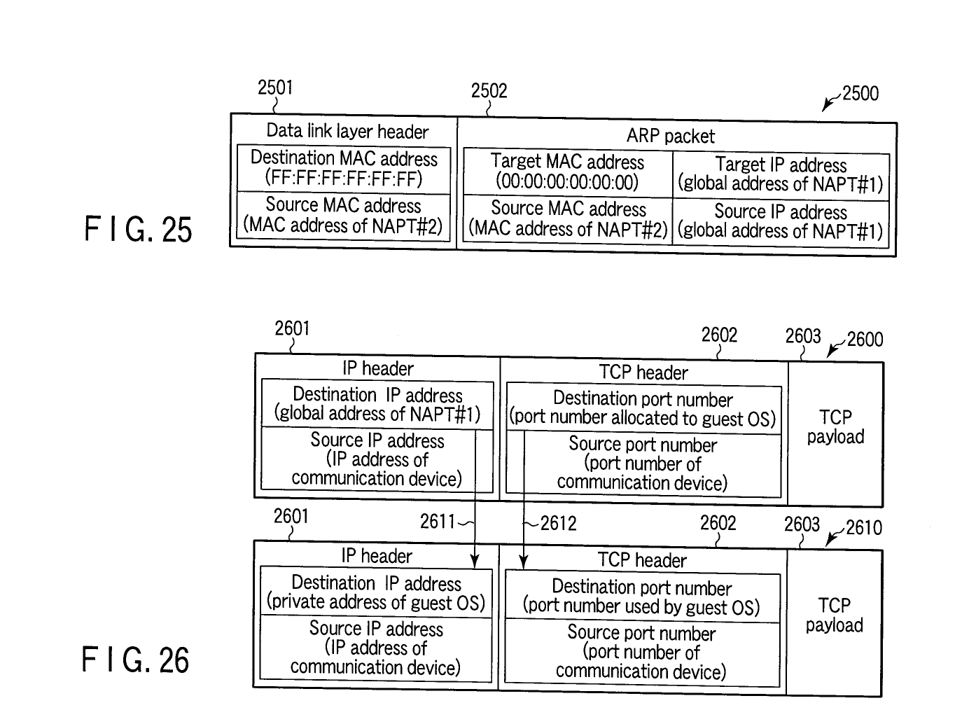

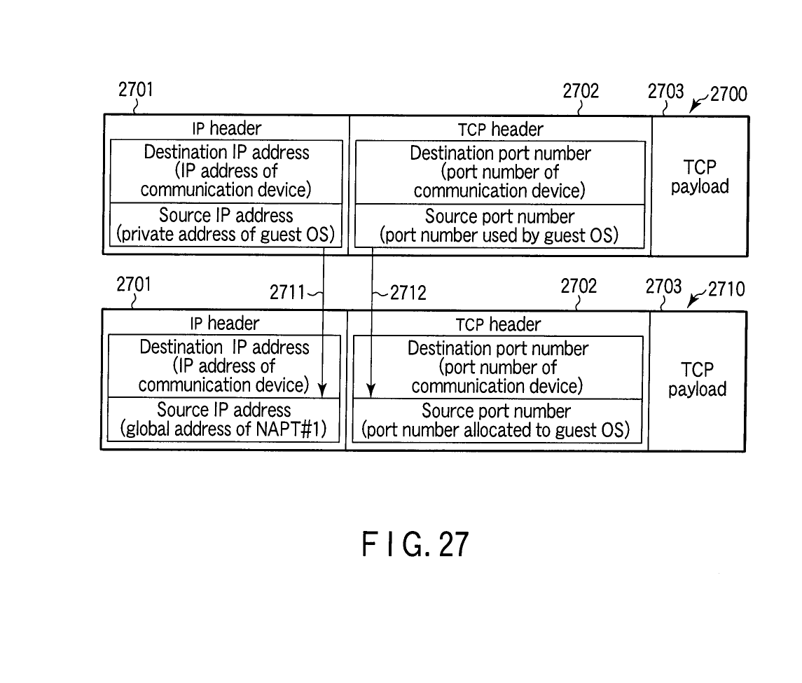

A communication sequence before and after the occurrence of a failure in migration source NAPT 140-1 applied to the system of FIG. 23 will be explained with reference to FIGS. 24 to 27, taking as an example a case where communication data is sent and received between guest OS 16 and communication device 24. FIG. 24 is a sequence chart to explain a communication sequence before and after the occurrence of a failure in migration source NAPT 140-1. FIG. 25 shows a format of gratuitous address resolution protocol (ARP). FIGS. 26 and 27 show examples of the format of communication data. In FIG. 24, the parts equivalent to those in FIG. 2 are indicated by the same reference numerals.

First, the communication sequence from the migration of guest OS 16 from hardware unit 11-1 (virtual machine monitor 12-1) to hardware unit 11-2 (virtual machine monitor 12-2) to a failure occurrence 231 in NAPT 140-1 is the same as in FIG. 2. When having detected a failure occurrence 231 in NAPT 140-1 (step 241), NAPT 140-2 takes over the IP address (global address) of NAPT 140-1. Then, NAPT 140-2 transmits gratuitous ARP (hereinafter, referred to as G-ARP) 2500, a special ARP request for informing all the nodes on LAN 21 including communication device 24 of the takeover of the IP address (global address), to LAN 21 in, for example, a broadcasting manner (step 242).

As shown in FIG. 25, G-ARP 2500 includes a data link layer header 2501 and an ARP packet 2502. The broadcast address and the MAC address of NAPT 140-2 are used as the destination MAC (media access control) address and source MAC address of data link layer header 2501, respectively. ARP packet 2502 includes a target MAC address, a target IP address, a source MAC address, and a source IP address. The MAC address of NAPT 140-2 is used as the source MAC address of ARP packet 2502. The global address (179.29.1.100) of NAPT 140-1, which NAPT 140-2 is to take over, is used as the target IP address and source IP address of ARP packet 2502.

After a node including communication device 24 on LAN 21 has received G-ARP 2500 from NAPT 140-2, it transmits the target address of NAPT 140-1 to NAPT 140-2. For example, communication device 24 transmits communication data 2600 in the format of FIG. 26 addressed to the migrated guest OS 16 to NAPT 140-2 via LAN 21 (step 243). Communication data 2600 includes an IP header 2601, a TCP header 2602, and a TCP payload 2603. IP header 2601 is composed of a destination IP address and a source IP address. The global address of NAPT 140-1 notified by G-ARP 2500 (that is, the global address of NAPT 140-1 taken over by NAPT 140-2) is used as the destination IP address of IP header 2601. The IP address of communication device 24 is used as the source IP address of IP header 2601. The port number allocated to guest OS 16 by NAPT 140-1 is used as the destination port number of TCP header 2602. The port number of communication device 24 is used as the source port number of TCP header 2602.

On the basis of the destination IP address in communication data 2600, NAPT 140-2 receives communication data 2600 addressed to guest OS 16 from communication device 24. Then, on the basis of its own translation table 128, NAPT 14-2 translates the destination IP address and destination port number (or performs address port translation) (step 244). Here, the destination IP address of IP header 2601 included in communication data 2600 is translated from the global address of NAPT 140-1 to the private address of guest OS 16 as shown by arrow 2611 in FIG. 26. Moreover, the destination port number of TCP header 2602 included in communication data 2600 is translated from the port number allocated to guest OS 16 into the port number used by guest OS 16 as shown by arrow 2612 in FIG. 26. NAPT 140-2 transmits communication data 2600 subjected to address port translation as communication data 2610 of FIG. 26 to guest OS 16 via virtual network 13-2 (step 245). Guest OS 16 receives communication data 2610 via the port specified by the destination port number of TCP header 2602.

Next, suppose, to respond to, for example, communication data 2610, guest OS 16 has transmitted communication data 2700 in the format of FIG. 27 to NAPT 140-2 via virtual network 13-2 (step 246). Communication data 2700 includes an IP header 2701, a TCP header 2702, and a TCP payload 2702. The IP header 2701 is composed of a destination IP address and a source IP address. The IP address of communication device 24 is used as the destination IP address of IP header 2701. The private address of guest OS 16 is used as the source IP address of IP header 2701. The port number of communication device 24 is used as the destination port number of TCP header 2702. The port number used by guest OS 16 is used as the source port number of TCP header 2702.

When having received communication data 2700 from guest OS 16, NAPT 140-2 translates the source IP address and source port number on the basis of its own translation table 128 (step 247). In this step, the source IP address of IP header 2701 included in communication data 2700 is translated from the private address of guest OS 16 into the global address of NAPT 140-1 as shown by arrow 2711 in FIG. 27. Moreover, the source port number of TCP header 2702 included in communication data 2700 is translated from the port number used by guest OS 16 into the port number allocated to guest OS 16 as shown by arrow 2712 in FIG. 4. NAPT 140-2 transmits communication data 2700 subjected to address port translation as communication data 2710 of FIG. 27 to communication device 24 via LAN 21 (step 248). Communication device 24 receives communication data 2710 via the port specified by the destination port number of TCP header 2702.

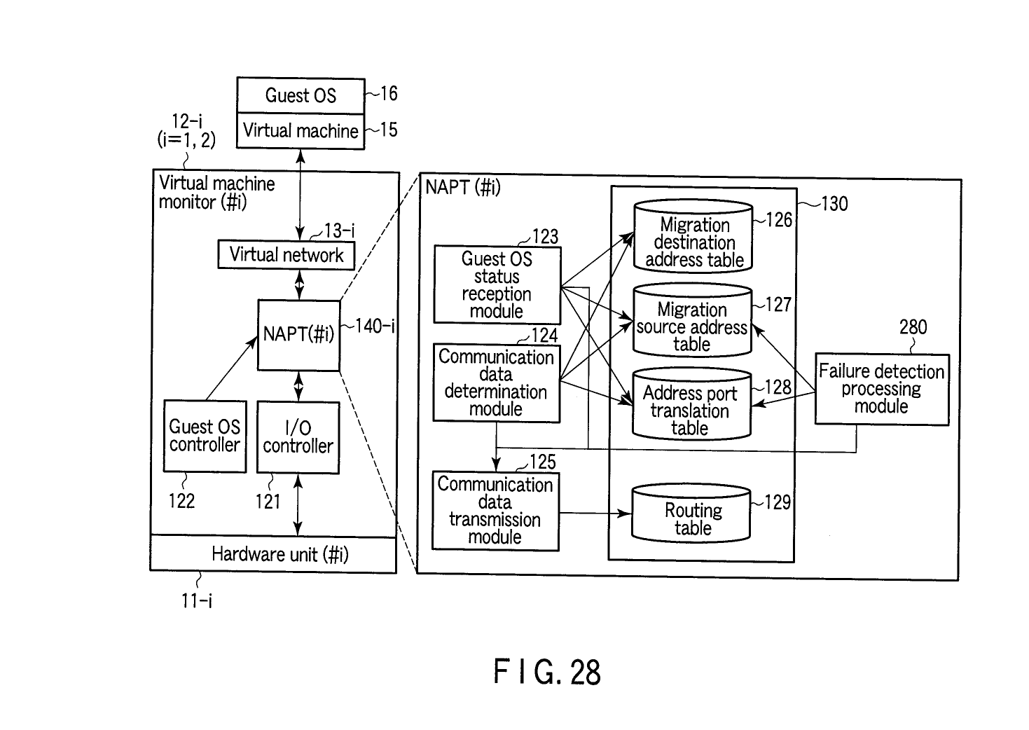

Next, the configuration of virtual machine monitor 12-i (i=1, 2) applied to the modification will be explained with reference to the block diagram of FIG. 28. In FIG. 28, the parts equivalent to those in FIG. 9 are indicated by the same reference numerals. In the modification, virtual machine monitor 12-i includes a virtual network 13-i, an NAPT 140-i, an input/output controller (I/O controller) 121, and a guest OS controller 122. Unlike NAPT 14-i of FIG. 9, NAPT 140-i is characterized in that a failure detection processing module 280 is added to NAPT 140-i.

The failure detection processing module 280 of NAPT 140-i executes the following two processes:

(1) Heartbeat periodic transmission

(2) Failure detection

The heartbeat periodic transmission process includes a process where failure detection processing module 280 of NAPT 140-i periodically sends and receives heartbeat data packets for checking for survival with the failure detection processing module of one other NAPT. The failure detection process includes a process where failure detection processing module 280 of NAPT 140-i detects an interruption of the heartbeat from the one other NAPT and transmits G-ARP for taking over the global address of the one other NAPT. The failure detection process further includes a process where failure detection processing module 280 of NAPT 140-i incorporates the contents of its own migration source address table 127 into its own translation table 128.

Next, the above two processes will be explained in detail. First, the heartbeat periodic transmission process will be described. Heartbeat data packets may be transmitted periodically by any suitable method, such as transmission via a network or transmission by use of serial-port-based special lines. In the modification, suppose heartbeat data packets are transmitted periodically by use of NAPT global addresses.

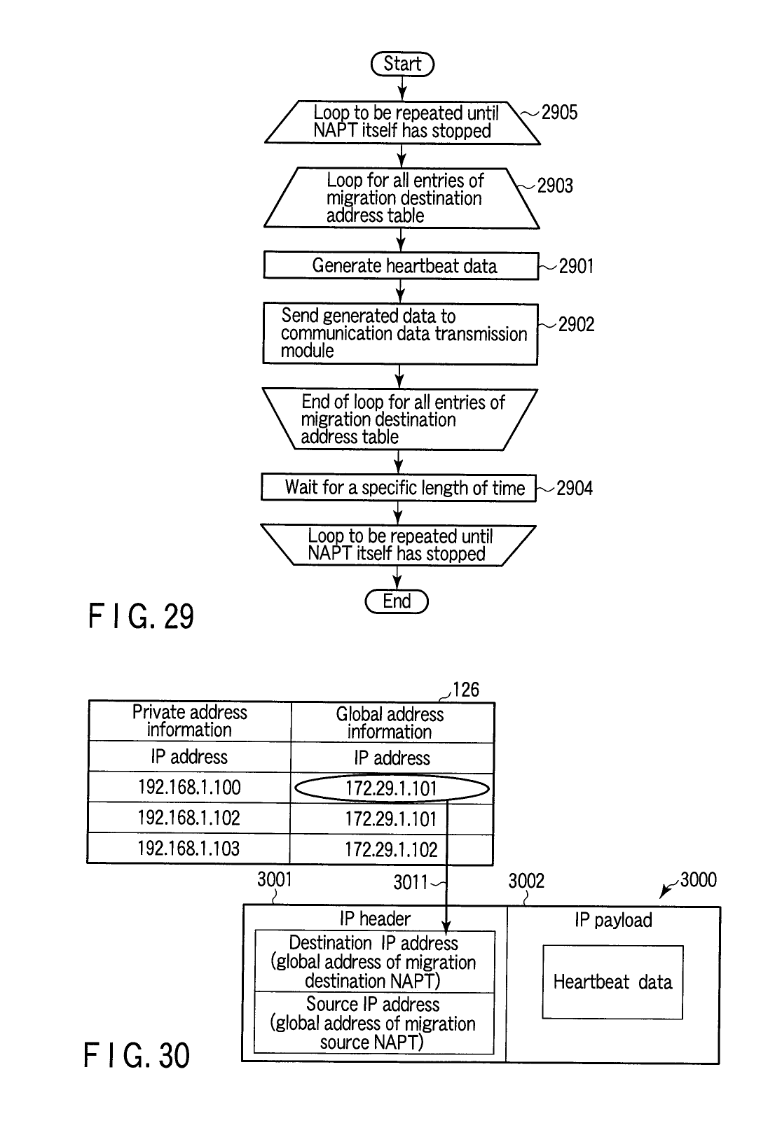

Hereinafter, the procedure for a heartbeat periodic transmission process at failure detection processing module 280 of NAPT 140-i will be explained with reference to a flowchart in FIG. 29 and a heartbeat data packet in FIG. 30. First, failure detection processing module 280 performs the following steps 2901 and 2902 repeatedly on all the global addresses entered in migration destination address table 126 of NAPT 140-i (step 2903).

In step 2901, failure detection processing module 280 generates a heartbeat data packet 3000 (see FIG. 30) addressed to the global address on the basis of the global address of the migration destination NAPT entered in the target entry of migration destination address table 126 of NAPT 140-i. The generated heartbeat data packet 3000 may take any form, provided that the global address of the migration destination NAPT is set as the destination (destination address) and at least data identifiable as heartbeat data is set in the data part.

In the modification, heartbeat data packet 3000 includes an IP header 3001 and an IP payload 3002 as shown in FIG. 30. The global address of the migration destination NAPT entered in migration destination address table 126 is used as the destination IP address of IP header 3001 as shown by arrow 3011 in FIG. 30. The global address of NAPT 140-i including failure detection processing module 280 (that is, the global address of the migration source NAPT) is used as the source IP address of IP header 3001. IP payload 3002 includes heartbeat data. The configuration of the data in IP payload 3002 may be such that the data is held in the TCP payload. Moreover, the port number may be used as information to identify heartbeat data set in an IP payload.

In step 2902, failure detection processing module 280 sends heartbeat data packet 3000 generated in step 2901 to transmission module 125. Then, transmission module 125 transmits heartbeat data packet 3000 sent from the module 280 to the migration destination NAPT via a network or the like. Failure detection processing module 280 performs the above processes (steps 2901 and 2902) on all the global addresses (the global address of the migration destination NAPT) entered in migration destination address table 126 (step 2903). Then, after having transmitted heartbeat data packet 3000 to all the global addresses entered in migration destination address table 126 (step 2903), failure detection processing module 280 waits for a specific length of time (step 2904).

After waiting for a specific length of time, failure detection processing module 280 repeats the above processes (steps 2901 and 2902). The waiting time (a specific length of time) may be set to any value. In the modification, suppose the waiting time is set to a time interval shorter than a heartbeat interruption detection time (described later) in heartbeat data packet 3000 at the destination NAPT. In this case, heartbeat data packets 3000 are transmitted periodically at intervals of time shorter than the heartbeat interruption detection time. The value representing the waiting time may be set in NAPT 140-i in advance or set by the user at the time of system start-up. Failure detection processing module 280 repeats the above processes (steps 2901 to 2904) until NAPT 140-i including the module 280 has stopped (step 2905).

Next, the failure detection process will be explained. The failure detection process is started when a data item is first entered in migration source address table 127 and carried out repeatedly until all data items are deleted from the table 127. Here, the same processes are performed repeatedly on all the global addresses entered in migration source address table 127.

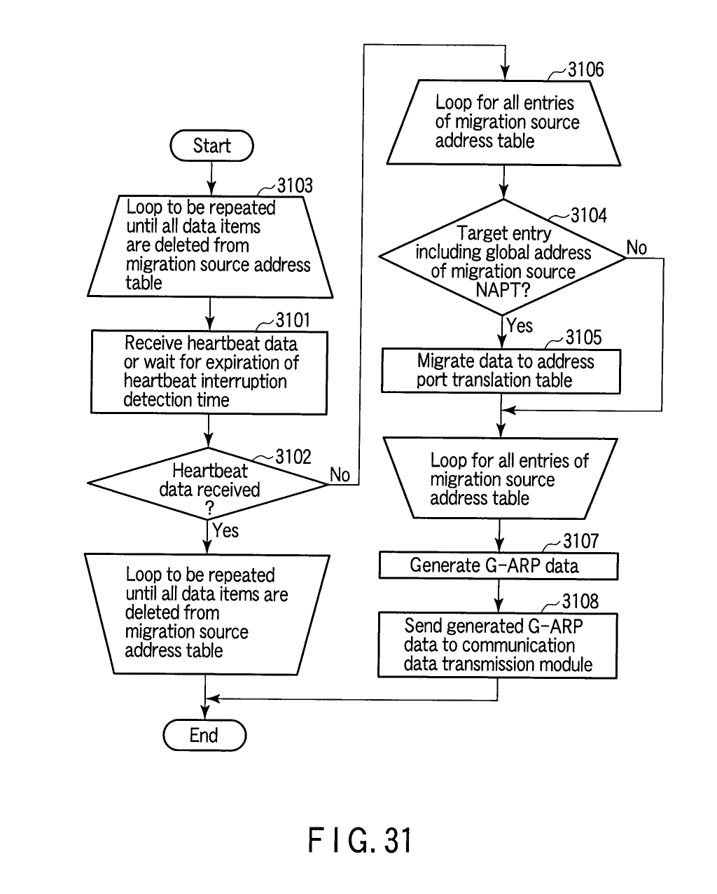

Hereinafter, the procedure for detecting a failure (or detecting a failure in the migration source NAPT) at failure detection processing module 280 of NAPT 140-i will be explained with reference to a flowchart in FIG. 31. First, failure detection processing module 280 waits until it receives heartbeat data (heartbeat data packet) from NAPT (i.e., migration source NAPT) with the migration source global address entered in migration source address table 127 or until the heartbeat interruption detection time has passed even if having received no heartbeat data (step 3101). Here, the heartbeat interruption detection time is set to the time required to determine that a failure has occurred in the migration source NAPT because no heartbeat data has been received. The value representing the heartbeat interruption detection time may be either set in NAPT 140-i in advance or set by the user at the time of system start-up.

After having waited in step 3101, failure detection processing module 280 determines whether it has received heartbeat data (step 3102). If the result of the determination is YES in step 3102, that is, if having received heartbeat data within the heartbeat interruption detection time, failure detection processing module 280 executes the waiting process in step 3101 again. Steps 3101 and 3102 are executed repeatedly until the data (the data including the global address information of the migration source NAPT) has been deleted from all the entries of migration address table 127 (step 3103).

In contrast, if the result of the determination is NO in step 3102, that is, if having received no heartbeat data even after the expiration of the heartbeat interruption detection time, failure detection processing module 280 determines that it has detected a heartbeat interruption due to the occurrence of a failure in the migration source NAPT. Then, as described below, failure detection processing module 280 takes over the process of the migration source NAPT in which a heartbeat interruption has been detected.

First, failure detection processing module 280 functions as an address port translation data migration module. Failure detection processing module 280 determines whether an entry of migration source address table 127 is the target entry including the global address (IP address) of the migration source NAPT where a heartbeat interruption has been detected (step 3104). If the entry is the target entry (YES in step 3104), failure detection processing module 280 migrates the data in the target entry (address port translation data) to an empty entry of translation table 128 (step 3105). Failure detection processing module 280 performs step 3104 on all the entries of migration source address table 127 repeatedly (step 3106). That is, of the data items in all the entries of migration source address table 127, failure detection processing module 280 adds to translation table 128 the data item in the target entry including the global address (IP address) of the migration source NAPT where a heartbeat interruption has been detected. At the same time, failure detection processing module 280 deletes the added data item in the target entry from migration source address table 127.

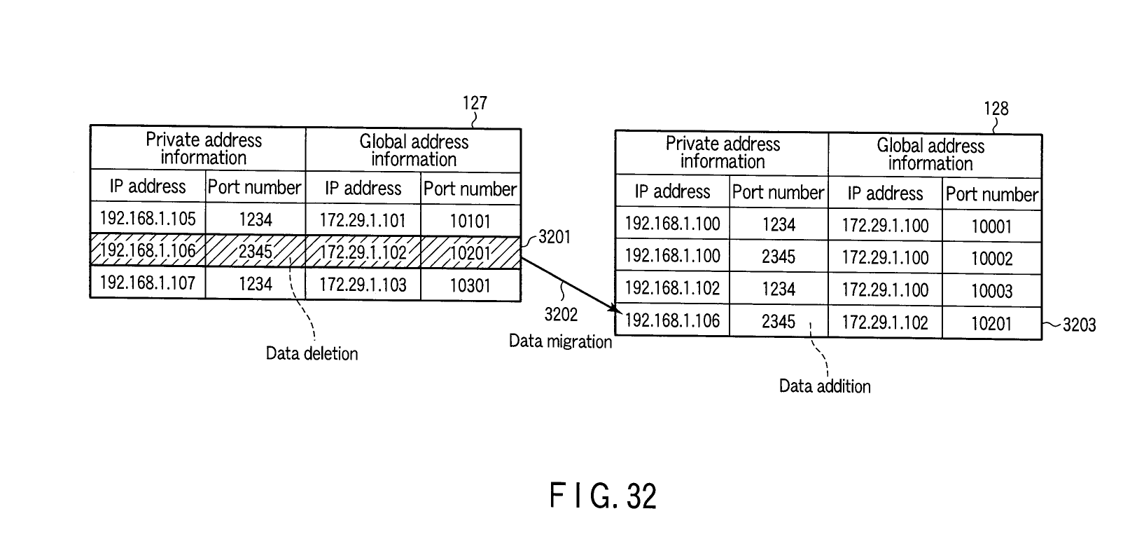

FIG. 32 is a diagram to explain the migration of the data item in the target entry from migration source address table 127 to translation table 128. First, suppose the global address (IP address) of the migration source NAPT where a heartbeat interruption has been detected is “172.29.1.201”. In the example of FIG. 32, entry 3201 where the address “172.29.1.201” is included in global address information exists in migration source address table 127. In this case, the data in entry 3201 of migration source address table 127 is migrated to empty entry 3203 of translation table 128 as shown by arrow 3202 in FIG. 32. That is, the data in entry 3201 of migration source address table 127 is added to entry 3203 of translation table 128 and the data in entry 3201 of migration source address table 127 is deleted.

Failure detection processing module 280 performs the above processes on all the entries of migration source address table 127 (step 3106), thereby generating a G-ARP packet (see FIG. 25) in which the global address (IP address) of the migration source NAPT where a heartbeat interruption has been detected has been set in the target IP address and source IP address (step 3107). Failure detection processing module 280 sends the generated G-ART packet to transmission module 125. Transmission module 125 broadcasts the G-ARP packet via LAN 21. This enables NAPT 140-2 including failure detection processing module 280 to take over the global address of the migration source NAPT where a heartbeat interruption has been detected.

The virtual machine system applied to the embodiment and its modification includes two hardware units (virtual machine monitors) on which a guest OS (virtual machine) using private addresses can operate. The virtual machine system may include more than two hardware units (virtual machine monitors). The virtual machine system may be replaced with a computer system where a real machine (physical computer) using private addresses is migrated between hardware units (network address port translation modules operating on hardware units) for reallocation.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. In a computer system which includes a first network address port translation module for connecting a first private network and a global network and a second network address port translation module for connecting a second private network and the global network, a method of controlling the communication between a machine using private addresses and a communication device connected to the global network, the method comprising:
detecting, by the second address port translation module, a migration of the machine from the first network address port translation module to the second network address port translation module;
storing address port translation data stored in a first storage module included in the first network address port translation module into a second storage module included in the second network address port translation module in such a manner that the second network address port translation module shares the address port translation data with the first network address port translation module, the address port translation data being used to translate a network address and a port number included in communication data on the machine;
translating, by the first network address port translation module, first communication data into second communication data when the first network address port translation module has received the first communication data, the first communication data being communication data addressed to the machine which has been transmitted from the communication device via the global network to the first network address port translation module in a state where the machine has been migrated from the first network address port translation module to the second network address port translation module and which includes a global address of the first network address port translation module as a destination network address, and the second communication data being generated by translating a destination network address in the first communication data into a global address of the second network address port translation module;
transferring the second communication data from the first network address port translation module to the second network address port translation module;
translating, by the second network address port translation module, the second communication data transferred to the second network address port translation module into third communication data, the third communication data being generated by translating a destination network address and a destination port number in the second communication data on the basis of address port translation data which is shared with the first network address port translation module and stored in the second storage module; and
transmitting the third communication data to the machine via the second private network.

2. The method according to claim 1, further comprising: informing, by the first network address port translation module, the second network address port translation module of the address port translation data stored in the first storage module in accordance with to the migration of the machine from the first network address port translation module to the second network address port translation module,
wherein the second network address port translation module detects the migration of the machine from the first network address port translation module to the second network address port translation module on the basis of the notice of the address port translation data from the first network address port translation module.

3. The method according to claim 2, further comprising:
translating, by the second network address port translation module, fourth communication data into fifth communication data when the second network address port translation module has received the fourth communication data, the fourth communication data being communication data transmitted from the machine via the second private network to the second network address port translation module in a state where the machine has been migrated from the first network address port translation module to the second network address port translation module, and the fifth communication data being generated by translating a source network address and a source port number in the fourth communication data on the basis of the address port translation data which is shared with the first network address port translation module and stored in the second storage module; and
transmitting the fifth communication data from the second network address port translation module to the communication device via the global network.

4. The method according to claim 3, further comprising adding a private address of the machine and a global address of the second network address port translation module to a migration destination address table stored in the first storage module in such a manner that the private address of the machine and the global address of the second network address port translation module are associated with each other when the machine has been migrated from the first network address port translation module to the second network address port translation module,
wherein the first network address port translation module translates the first communication data into the second communication data on the basis of the migration destination address table stored in the first storage module.

5. The method according to claim 4, wherein:
the address port translation data includes a pair of private address information and global address information, the private address information being composed of a private address and a port number used by the machine, and the global address information being composed of the global address of the first network address port translation module and a port number allocated to the machine by the first network address port translation module,
the storing includes adding the address port translation data to a migration source address table stored in the second storage module when the first network address port translation module has informed the second network address port translation module of the address port translation data,
the fourth communication data includes the private address and port number of the migrated machine as a source network address and a source port number, and
the second network address port translation module translates the source network address and source port number in the fourth communication data from the private address and port number of the migrated machine into the global address of the first network address port translation module and the port number allocated to the migrated machine by the first network address port translation module, respectively, on the basis of the migration source address table stored in the second storage module.

6. The method according to claim 5, further comprising:
determining whether communication data addressed to the machine is either the first communication data or sixth communication data, on the basis of whether a private address coinciding with the source network address in the communication data addressed to the machine exists in the migration destination address table stored in the first storage module when the first network address port translation module has received the communication data addressed to the machine, the sixth communication data being communication data addressed to the machine which has been transmitted from the communication device to the first network address port translation module via the global network in a state where the machine has not been migrated from the first network address port translation module to the second network address port translation module;
translating, by the first network address port translation module, the sixth communication data into seventh communication data when the communication data addressed to the machine is the sixth communication data, the seventh communication data being generated by translating a destination network address and a destination port number in the sixth communication data into a private address and a port number used by the machine on the basis of the address port translation data stored in the first storage module; and
transmitting the seventh communication data from the first network address port translation module to the machine via the first private network.

7. The method according to claim 6, further comprising:
determining whether communication data from the machine is eighth communication data on the basis of whether address port translation data including private address information coinciding with the source network address and source port number in the communication data from the machine exists in the first storage module when the first network address port translation module has received the communication data from the machine, the eighth communication data being communication data from the machine in a state where the machine has not been migrated from the first network address port translation module to the second network address port translation module;
translating, by the first network address port translation module, the eighth communication data into ninth communication data when the communication data from the machine is the eighth communication data, the ninth communication data being generated by translating a source network address and a source port number in the eighth communication data into a global address and a port number constituting global address information stored in the address port translation data including the coinciding private address information; and
transmitting the ninth communication data from the second network address port translation module to the communication device via the global network.

8. The method according to claim 7, further comprising determining whether the communication data from the machine is the fourth communication data, on the basis of whether private address information coinciding with the source network address and source port number in the communication data from the machine exists in the migration source address table stored in the second storage module when the second network address port translation module has received communication data from the machine.

9. The method according to claim 8, further comprising when the second network address port translation module has received communication data addressed to the machine, determining whether the communication data addressed to the machine is the second communication data, on the basis of whether global address information including a port number coinciding with the destination port number in the communication data addressed to the machine exists in the migration source address table,
wherein the third communication data is generated by translating a destination network address and a destination port number in the second communication data into a private address and a port number constituting private address information stored in the migration source address table in such a manner that the private address information is paired with global address information including a port number coinciding with the destination port number.

10. The method according to claim 4, further comprising:
periodically checking, by the second network address port translation module at the migration destination of the migrated machine, for the occurrence of a failure in the first network address port translation module at the migration source of the migrated machine;
migrating, by the second network address port translation module, address port translation data including the global address of the first network address port translation module which exists in the migration source address table stored in the second storage module to an address port translation table stored in the second storage module used to hold address port translation data managed by the second network address port translation module when the occurrence of a failure in the first network address port translation module has been checked for; and
transmitting, by the second network address port translation module, a special address reply protocol request for taking over the global address of the first network address port translation module to the global network in a broadcasting manner when the occurrence of a failure in the first network address port translation module has been checked for.

11. A computer system comprising:
a plurality of private networks to which machines using private addresses are capable of being connected; and
network address port translation modules which are provided for the plurality of private networks in a one-to-one correspondence and are configured to communicate with one another via a global network and each of which is configured to connect the corresponding one of the plurality of private networks and the global network and comprising:
a storage module configured to store address port translation data which is used to translate a network address and a port number included in communication data on a machine connected to the private network and is managed by each of the network address port translation modules;
a detection module configured to detect the migration of the machine from one other network address port translation module to said each of the network address port translation modules;
an address port translation data addition module configured to add address port translation data managed by the one other network address port translation module to the storage module according to the detection of the migration of the machine by the detection module, the added address port translation data being used to translate a network address and a port number in communication data on the machine the migration of which has been detected;
translation means for translating first communication data into second communication data when the first communication data addressed to the machine which has been transmitted from a communication device connected to the global network to said each of the network address port translation modules via the global network has been received by said each of the network address port translation modules, the first communication data not only being communication data addressed to the machine which has been transmitted from the communication device in a state where the machine has been migrated from said each of the network address port translation modules to the one other network address port translation module but also including the global address of said each of the network address port translation modules as a destination network address, and the second communication data being generated by translating the destination network address in the first communication data into the global address of the one other network address port translation module; and
a transmission module configured to transfer the second communication data to the one other network address port translation module via the global network,
wherein:
the translation means translates second communication data into third communication data when the second communication data has been transferred from a transmission module of the one other network address port translation module in a state where the machine has been migrated from the one other network address port translation module to said each of the network address port translation modules, the third communication data being generated by translating a destination network address and a destination port number in the transferred second communication data on the basis of the address port translation data added to the storage module; and
the transmission module is configured to transmit the third communication data to the machine via the private network.

12. The computer system according to claim 11, further comprising an address port translation data packet generation module configured to generate an address port translation data packet for informing the one other network address port translation module of the address port translation data stored in the storage module in accordance with to the migration of the machine from said each of the network address port translation modules to the one other network address port translation module,
wherein:
the transmission module is configured to transmit the generated address port translation data packet to the one other network address port translation module; and
the detection module is configured to detect the migration of the machine on the basis of the address port translation data packet when the address port translation data packet transmitted from the transmission module of the one other network address port translation module in accordance with the migration of the machine from the one other network address port translation module to each of the network address port translation modules has been received by said each of the network address port translation modules.

13. The computer system according to claim 12, wherein:
the translation means translates fourth communication data into fifth communication data when the fourth communication data has been received by said each of the network address port translation modules, the fourth communication data being communication data transmitted from the machine to said each of the network address port translation modules via the private network in a state where the machine has been migrated from the one other network address port translation module to said each of the network address port translation modules, and the fifth communication data being generated by translating a source network address and a source port number in the fourth communication data on the basis of the address port translation data added to the storage module; and
the transmission module is configured to transmit the fifth communication data to the communication device via the global network.

14. The computer system according to claim 13, further comprising:
a migration destination address table stored in the storage module which holds a private address of the migrated machine and a global address of the network address port translation module at the migration destination of the migrated machine in association with each other; and
a migration destination address table data addition module configured to add a private address of the machine and a global address of the one other network address port translation module to the migration destination address table in such a manner that the private address of the machine and the global address of the one other network address port translation module are associated with each other when the machine has been migrated from said each of the network address port translation modules to the one other network address port translation module,
wherein the translation means translates the first communication data into the second communication data on the basis of the migration destination address table.

15. The computer system according to claim 14, further comprising a migration source address table stored in the storage module which holds private address information and global address information in association with each other, the private address information being composed of a private address and a port number used by the machine migrated from the one other network address port translation module to each of the network address port translation modules, and the global address information being composed of a global address of the one other network address port translation module at a migration source of the migrated machine and a port number allocated to the migrated machine by the one other network address port translation module at the migration source,
wherein:
the address port translation data informed by the address port translation data packet includes a pair of private address information and global address information, the private address information being composed of a private address and a port number used by the migrated machine, and the global address information being composed of a global address of a network address port translation module at the migration source of the migrated machine and a port number allocated to the migrated machine by the network address port translation module at the migration source;
the fourth communication data includes the private address and port number of the migrated machine as a source network address and a source port number, respectively;
the address port translation data addition module is configured to add the address port translation data informed by the address port translation data packet to the migration source address table when the address port translation data packet transmitted from the transmission module of the one other network address port translation module has been received by said each of the network address port translation modules; and
the translation means, when the fourth communication data has been received by said each of the network address port translation modules, translates the source network address and source port number in the received fourth communication data from the private address and port number of the migrated machine to the global address of the one other network address port translation module at the migration source and the port number allocated to the migrated machine by the one other network address port translation module, respectively, on the basis of the migration source address table.

16. The computer system according to claim 15, further comprising first determination module configured to determine whether communication data addressed to the machine is either the first communication data or sixth communication data on the basis of whether a private address coinciding with a source network address in the communication data addressed to the machine exists in the migration destination address table when the communication data addressed to the machine transmitted from the communication device via the global network to said each of the network address port translation modules has been received by said each of the network address port translation modules, the sixth communication data being communication data addressed to the machine which has been transmitted from the communication device to said each of the network address port translation modules via the global network in a state where the machine has not been migrated from said each of the network address port translation modules to the one other network address port translation module,
wherein:
the translation means, when the communication data addressed to the machine is the sixth communication data, causes the first network address port translation module to translate the sixth communication data into seventh communication data, the seventh communication data being generated by translating a destination network address and a destination port number in the sixth communication data into a private address and a port number used by the machine on the basis of the address port translation data stored in the storage module; and
the transmission module is configured to transmit the seventh communication data to the machine via the private network.

17. The computer system according to claim 16, further comprising second determination module configured to determine whether communication data from the machine is eighth communication data on the basis of whether address port translation data including private address information coinciding with the source network address and source port number in the communication data from the machine exists in the storage module when the communication data from the machine has been received by said each of the network address port translation modules, the eighth communication data being communication data from the machine in a state where the machine has not been migrated from each of the network address port translation modules to the one other network address port translation module,
wherein:
the translation means, when the communication data from the machine is the eighth communication data, translates the eighth communication data into ninth communication data, the ninth communication data being generated by translating a source network address and a source port number in the eighth communication data into a global address and a port number constituting global address information stored in the address port translation data including the coinciding private address information; and
the transmission module is configured to transmit the ninth communication data to the communication device via the global network.

18. The computer system according to claim 17, further comprising third determination module configured to determine whether communication data from the machine is the fourth communication data on the basis of whether private address information coinciding with the source network address and source port number in the communication data from the machine exists in the migration source address table when the communication data from the machine has been received by said each of the network address port translation modules.

19. The computer system according to claim 18, further comprising fourth determination module configured to determine whether communication data addressed to the machine is the second communication data on the basis of whether global address information including a port number coinciding with the destination port number in the communication data addressed to the machine exists in the migration source address table when the communication data addressed to the machine has been received by said each of the network address port translation modules,
wherein the third communication data is generated by translating a destination network address and a destination port number in the second communication data into a private address and a port number constituting private address information stored in the migration source address table in such a manner that the private address information is paired with global address information including a port number coinciding with the destination port number.
